(19) United States
(12) Patent Application Publication
(10) Pub. No.: US 2006/0080340 A1
(43) Pub. Date: Apr. 13, 2006

(54) Communication system, communication apparatus, and communication method

(76) Inventor: Hirokazu Oi, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/225,830

(22) Filed: Sep. 13, 2005

(30) Foreign Application Priority Data
Sep. 13, 2004 (JP) 2004-265931

(51) Int. Cl. G06F 7/00

(52) U.S. Cl. 707/100

(57) ABSTRACT

In a communication system for transmitting/receiving files between a plurality of apparatuses, a transmission end includes an identification information transmitting unit which transmits identification information of a self-apparatus, and a file transmitting unit which transmits a file and file name owned by the self-apparatus, and a reception end includes an identification information receiving unit which receives the identification information of the transmission end, a file receiving unit which receives the file and file name transmitted from the transmission end, and a file name determination unit which determines a file name to be given upon storing the received file in the self-apparatus on the basis of the identification information and file name received from the transmission end.

### FIELD OF THE INVENTION

The present invention relates to a communication technique for transmitting/receiving files among a plurality of apparatuses.

### BACKGROUND OF THE INVENTION

Some conventional information processing apparatuses handle data as files, and execute transmission/reception processing (synchronous processing) of files among another apparatus.

For example, in Japanese Patent Laid-Open No. 2001-117800, a shared apparatus identifies users, and manages files obtained by synchronous processing with terminals for respective users.

In Japanese Patent Laid-Open No. 2003-101839, an image sensed by another camera is sent to a self-camera.

The above prior arts suffer the following problem. That is, the problem is how to name files received from a partner apparatus.

Once a file is received from a partner apparatus, and is not used later, no trouble occurs irrespective of its naming method. However, when synchronous processing is to be repetitively done with a given terminal, a consistent naming method is preferably adopted to indicate that the file of interest has already been possessed. In this case, it is most convenient to adopt the same file name as that given by the transmission source of that file. However, when such naming method is adopted, if synchronous processing is executed with a third terminal, and a first terminal already has a file with different contents but the same name (assume that this file is obtained by synchronous processing with a second terminal), the problem is how to cope with it.

In recent years, apparatuses which store files in storage media like electronic still cameras (to be simply referred to as digital cameras hereinafter) have appeared. Upon saving files, names are often automatically given to files without any manual operations. In this case, since files are named on the basis of given rules, it is natural to give the same file names even to different files among different apparatuses. Upon executing the synchronous processing in such situation, the aforementioned naming problem occurs.

The present invention has been made in consideration of the above problems, and has as its first object to provide a technique which can give a name to a file so as to be distinguished from a file received from another apparatus even if these files have the same name, and can avoid wasteful file transmission/reception processing, upon executing the transmission/reception processing of files among unspecified three or more apparatuses.

It is the second object of the present invention to provide a technique which can give names to files to comply with the file system standard used when an apparatus writes a file on a storage medium.

It is the third object of the present invention to provide a technique which, even when the name of a file received from a communication partner is the same as that of a file received previously, if these files have different contents, can receive that file as a file different from the previously received file.

It is the fourth object of the present invention to provide a technique which, when files are transmitted/received between two apparatuses, can inhibit transmission of files to apparatuses other than the two apparatuses.

It is the fifth object of the present invention to provide a technique which can efficiently complete transmission/reception processing of files among all of a plurality of (five or more) apparatuses.

It is the sixth object of the present invention to provide a technique which can apply copyright protection when transmission/reception processing of files is executed among unspecified, many apparatuses.

### SUMMARY OF THE INVENTION

In order to solve the aforementioned problems and to achieve the above objects, a communication system according to the present invention is a communication system for transmitting/receiving files between a plurality of apparatuses, wherein a transmission end comprises: identification information transmitting means for transmitting identification information of the self-apparatus; and file transmitting means for transmitting a file and file name owned by the self-apparatus, and a reception end comprises: identification information receiving means for receiving the identification information of the transmission end; file receiving means for receiving the file and file name transmitted from the transmission end; and file name determination means for determining a file name to be given upon storing the received file in the self-apparatus on the basis of the identification information and file name received from the transmission end.

A communication apparatus according to the present invention is a communication apparatus for receiving a file from another apparatus, comprising: identification information receiving means for receiving identification information from a transmission end; file receiving means for receiving a file and file name transmitted from the transmission end; and file name determination means for determining a file name to be given upon storing the received file in the self-apparatus on the basis of the identification information and file name received from the transmission end.

A communication system according to the present invention is a communication system in which a second apparatus which receives a file from a first apparatus transmits the file received from the first apparatus to a third apparatus, wherein the first apparatus comprises: transmission means for transmitting a file owned by the self-apparatus and inhibition information that inhibits the file from being transmitted to the third apparatus, and the second apparatus comprises: receiving means for receiving the file owned by the first apparatus and the inhibition information; storing means for storing the file owned by the first apparatus in association with the inhibition information; and transmitting means for transmitting files owned by the self-apparatus except for the file associated with the inhibition information to the third apparatus.

A communication apparatus according to the present invention is a communication apparatus for receiving a file from another apparatus, comprising: storing means for storing information of an apparatus which completes a communication; judging means for judging if an apparatus which can communicate with the self-apparatus and does not complete the communication exists; receiving means for receiving a file from the judged apparatus; and control means for executing reception of files by the receiving means until the judging means judges that no apparatus which does not complete the communication exists, and for, when the judging means judges that no apparatus which does not complete the communication exists, erasing the information of the apparatuses stored in the storing means.

A communication method according to the present invention is a communication method for transmitting/receiving files between a plurality of apparatuses, wherein a transmission end comprises: an identification information transmitting step of transmitting identification information of the self-apparatus; and a file transmitting step of transmitting a file and file name owned by the self-apparatus, and a reception end comprises: an identification information receiving step of receiving the identification information of the transmission end; a file receiving step of receiving the file and file name transmitted from the transmission end; and a file name determination step of determining a file name to be given upon storing the received file in the self-apparatus on the basis of the identification information and file name received from the transmission end.

A communication method according to the present invention is a communication method for receiving a file from another apparatus, comprising: an identification information receiving step of receiving identification information from a transmission end; a file receiving step of receiving a file and file name transmitted from the transmission end; and a file name determination step of determining a file name to be given upon storing the received file in the self-apparatus on the basis of the identification information and file name received from the transmission end.

A communication method according to the present invention is a communication method in which a second apparatus which receives a file from a first apparatus transmits the file received from the first apparatus to a third apparatus, wherein the first apparatus comprises: a transmission step of transmitting a file owned by the self-apparatus and inhibition information that inhibits the file from being transmitted to the third apparatus, and the second apparatus comprises: a receiving step of receiving the file owned by the first apparatus and the inhibition information; a storing step of storing the file owned by the first apparatus in association with the inhibition information; and a transmitting step of transmitting files owned by the self-apparatus except for the file associated with the inhibition information to the third apparatus.

A communication method according to the present invention is a communication method for receiving a file from another apparatus, comprising: a storing step of storing information of an apparatus which completes a communication; a judging step of judging if an apparatus which can communicate with the self-apparatus and does not complete the communication exists; a receiving step of receiving a file from the judged apparatus; and a control step of executing reception of files in the receiving step until it is judged in the judging step that no apparatus which does not complete the communication exists, and erasing, when it is judged in the judging step that no apparatus which does not complete the communication exists, the information of the apparatuses stored in the storing step.

Note that the present invention can also be implemented by a program for making a computer implement the above communication method, and a computer-readable storage medium storing that program.

As described above, according to the present invention, when transmission/reception processing of files is executed among unspecified three or more apparatuses, a name can be given to a file so as to be distinguished from a file received from another apparatus even if these files have the same name, and wasteful file transmission/reception processing can be avoided.

More specifically, when a first apparatuses transmits/receives files with second and third apparatuses, even when the second and third apparatuses have files with the same name, a consistent file naming method is adopted so as to distinctively transmit/receive these files upon storing a file received from another apparatus. In this manner, even when the transmission/reception processing is repetitively executed with a given apparatus, whether or not a given file is received previously can be judged, and wasteful file transmission/reception processing can be avoided.

A file name can be given to comply with a predetermined file system standard (e.g., the Design rule for Camera File system (to be abbreviated as DCF hereinafter) in digital cameras) when an apparatus writes files in a storage medium.

Even when the name of a file received from a communication partner is the same as that of a file received previously, if these have different contents, that file can be received as one different from the previously received file.

When files are to be transmitted/received between two apparatuses, transmission of files to an apparatus other than these two apparatuses can be inhibited.

The transmission/reception processing of files among a plurality of (five or more) apparatuses can be efficiently completed among all these apparatuses.

Also, the technique that can apply copyright protection when transmission/reception processing of files is executed among unspecified, many apparatuses can be provided.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a diagram showing the network arrangement of digital cameras according to an embodiment of the present invention;

FIG. 2 is a block diagram showing the internal arrangement of an digital camera;

FIG. 3 shows the directory configurations of digital cameras before and after synchronization;

FIG. 4 is a flowchart showing synchronous procedure 1 between two cameras;

FIG. 5 is a flowchart showing synchronous procedure 2 between two cameras;

FIG. 6 is a flowchart showing synchronous procedure 3 between two cameras;

FIG. 7 is a flowchart showing synchronous procedure 3 between two cameras;

FIG. 8 is a flowchart showing transmission procedure 1 of an owned file list;

FIG. 9 is a flowchart showing transmission procedure 1 of a non-owned file list;

FIG. 10 is a flowchart showing synchronous procedure 4 between two cameras;

FIG. 11 shows the directory configurations when files obtained from another camera by synchronous processing are to be managed for respective cameras using directories;

FIG. 12 is a flowchart showing synchronous procedure 5 between two cameras;

FIG. 13 is a flowchart showing transmission procedure 2 of an owned file list;

FIG. 14 is a flowchart showing transmission procedure 2 of a non-owned file list;

FIG. 15 shows the directory configurations when files obtained from another camera by synchronous processing are to be managed for respective cameras using directories, and the directory paths of files stored in another camera are held;

FIG. 16 is a flowchart showing synchronous procedure 6 for implementing the file and directory configurations shown in FIG. 15;

FIG. 17 is a flowchart showing transmission procedure 3 of an owned file list;

FIG. 18 is a flowchart showing transmission procedure 3 of a non-owned file list;

FIG. 19 shows an example of the directory and file configurations before and after synchronization when camera A is synchronized with cameras B and C;

FIG. 20 is a correspondence table among the storage file name, camera ID, and original file name;

FIG. 21 shows an example of the directory and file configurations before and after synchronization when camera A is synchronized with cameras B and C;

FIG. 22 is a correspondence table between the directory name and camera ID;

FIG. 23 shows an example of the directory and file configurations before and after synchronization when camera A is synchronized with cameras B and C;

FIG. 24 is a correspondence table among the storage directory name, camera ID, and original directory name;

FIG. 25 is a flowchart showing transmission procedure 4 of an owned file list;

FIG. 26 is a flowchart showing transmission procedure 4 of a non-owned file list;

FIG. 27 is a flowchart showing synchronous procedure 7 from camera A to camera B when file list transmission procedures 4 shown in FIGS. 25 and 26 are used;

FIG. 28 is a flowchart showing synchronous procedure 9 from camera A to camera B when file list transmission procedures 2 shown in FIGS. 13 and 14 are used;

FIG. 29 is a flowchart showing a file name determination procedure;

FIG. 30 is a flowchart showing a file transmission/reception procedure;

FIG. 31 is a flowchart showing owned file list transmission procedure 5 in transmission-inhibition settings;

FIG. 32 is a flowchart showing the synchronous procedure when synchronous processing is mutually executed among three or more apparatuses;

FIG. 33 is a flowchart showing owned file list transmission procedure 6 when files sensed by the self-apparatus are not added to those owned by the self-apparatus;

FIG. 34 is a flowchart showing synchronous procedure 10 between two cameras; and

FIG. 35 is a flowchart showing synchronous procedure 10 between two cameras.

### DETAILED DESCRIPTION OF THE PREFERRED EMBODIMENTS

The best mode of carrying out the present invention will be described in detail hereinafter with reference to the accompanying drawings.

Note that embodiments to be described hereinafter are examples as implementation means of the present invention, and are modified or changed appropriately depending on the arrangements of apparatuses to which the present invention is applied, and various conditions. Hence, the present invention is not limited to the following embodiments.

Also, the present invention is also achieved by supplying a storage medium (or recording medium), which records a program code of a software program that can implement the functions of the following embodiments to the system or apparatus, and reading out and executing the program code stored in the storage medium by a computer (or a CPU or MPU) of the system or apparatus.

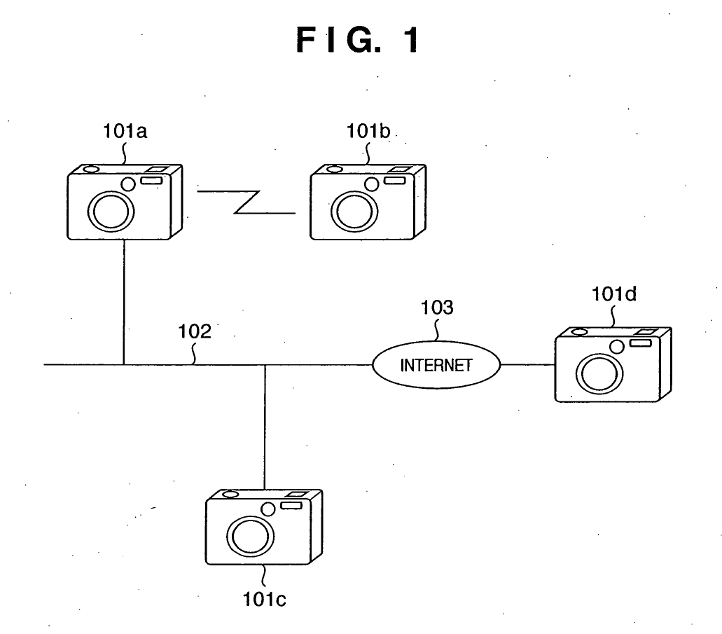

FIG. 1 shows the network arrangement of digital cameras as one embodiment according to the present invention.

Referring to FIG. 1, reference numeral 101 denotes digital cameras (a simple description “camera” like in FIG. 1 means an digital camera). Reference numeral 102 denotes a LAN; and 103, the Internet. Digital cameras 101a and 101b are wirelessly connected. The wireless connection method is not particularly limited, and for example, an infrared ray method, wireless LAN, Bluetooth, and the like may be used. Digital cameras 101a and 101c are connected by a wire via the LAN 102. Digital cameras 101a and 101d are connected via the Internet 103.

FIG. 1 shows that the present invention is applied to any of these connection patterns of the digital cameras, and the connection patterns are not particularly limited.

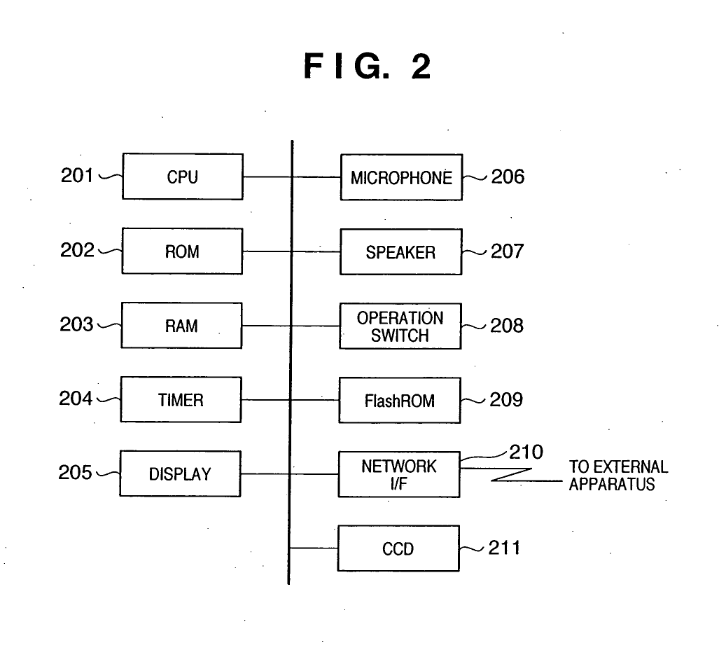

FIG. 2 is a block diagram showing the internal arrangement of the digital camera.

Referring to FIG. 2, the digital camera 101 comprises a central processing unit (to be abbreviated as CPU hereinafter) 201 for controlling the overall digital camera 101, a ROM 202 which readably stores various operation programs, a RAM 203 which is used to temporarily save values during program operations, a timer 204 which measures various time periods, a display 205 which displays various setting menus and images, a microphone 206 which is used in audio recording, a speaker 207 which is used in sound output, various operation switches 208, a FlashROM 209 which is a nonvolatile memory used to save sensed image files and various setting data files, a network I/F 210 which serves as an interface that connects the LAN 102, and a charge coupled device (to be abbreviated as CCD hereinafter) 211 which converts light focused via a lens (not shown) into an electrical signal. These components are connected to each other via a bus.

Note that the FlashROM 209 may be incorporated in the digital camera 101 or may be mounted on a memory card that can be inserted externally.

The storage location of image files sensed by the digital camera 101 may be the RAM 203 or a storage medium such as a hard disk or the like in addition to the FlashROM 209. In general, the storage location of image files is not particularly limited as long as it is a writable storage medium and a file can be created. In this embodiment, assume that image files are recorded on the FlashROM 209.

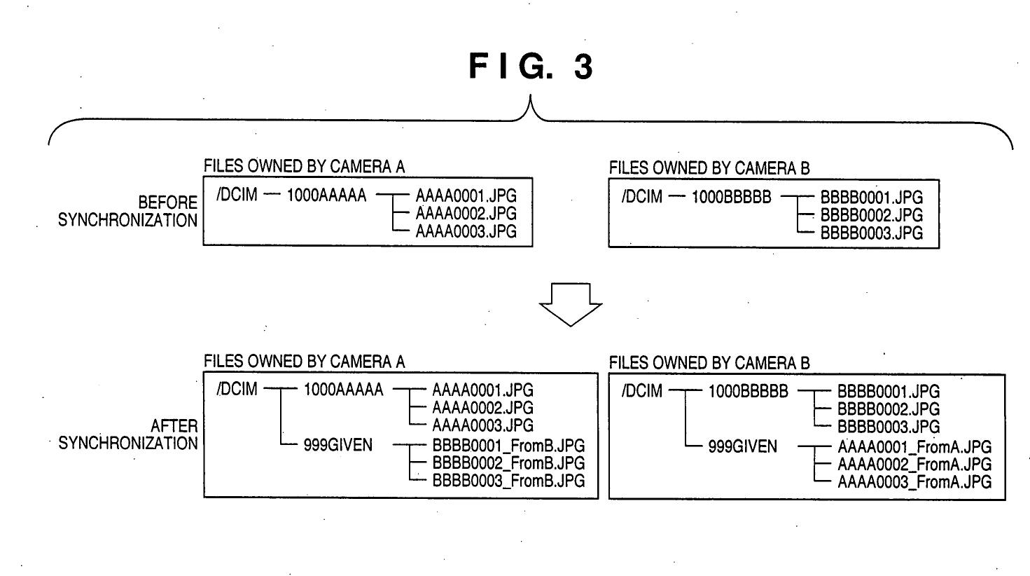

The states of files stored in the FlashROMs 209 upon executing transmission/reception processing (synchronous processing) of files between camera A (e.g., digital camera 101a) and camera B (e.g., digital camera 101b) will be described below using FIG. 3.

Referring to FIG. 3, as the states of files owned by camera A before synchronization, a directory DCIM is present under a root directory, a directory 100AAAAA is present under the directory DCIM, and three JPEG image files (AAAA0001.JPG, AAAA0002.JPG, and AAAA0003.JPG) are present under the directory 100AAAAA.

In the subsequent similar drawings, symbols indicate the names of directories except for JPEG files with JPG extensions.

The states of files owned by camera B before synchronization are as shown in FIG. 3.

Note that this image file storage format complies with the Design rule for Camera File system (DCF) Version 1.0 specified by Japan Electronics Development Association (JEIDA).

When camera A executes file synchronous processing with camera B, the states of files after synchronization are as shown in FIG. 3. That is, files received from camera B by camera A are stored under newly created directory 999GIVEN. In this case, the name of file BBBB0001.JPG of camera B is changed to BBBB0001_FromB.JPG. The same applies to BBBB0002.JPG and BBBB0003.JPG.

If the name BBBB0001.JPG is left unchanged, and if camera C (not shown) as a third camera has a file with the same name, that file is indistinctive from that received from camera B when camera A executes synchronous processing with camera C. By appending a character string “_FromB” to the file name, the CPU 201 can detect that the file is received from camera B.

Note that B is for camera B. If the user gives another name to camera B, that name may be used. In place of the name given by the user, a character string which can identify an individual camera like a serial number of an apparatus may be used. That is, character string which can identify the camera can be used. Also, the identification number of the network I/F 210 of the camera may be used to distinguish that camera. For example, when the network I/F 210 supports Internet Protocol Version 6 (IPv6), that network I/F 210 is globally and uniquely identified, and this number may be used to identify the camera. When the network I/F 210 is incorporated in the camera, it can be used to just identify the camera. Even when the network I/F 210 is externally connected, it may be rarely replaced, and no practical problem is posed.

When the file obtained by the synchronous process is named as BBBB0001_FromB.JPG, the file name breaks the rule of the so-called 8.3 format (in the file name, eight or less characters, separated by a period from an extension of up to three characters), and also the DCF standard.

Assume that camera A permits such naming of files. Since such naming is permitted, files obtained from any cameras can be stored under one directory, and a camera from which a file is obtained can be judged based on only its file name.

For example, after that, when camera A executes synchronous processing with camera C having a file BBBB0001.JPG, that file can be stored under the directory 999GIVEN with a name BBBB0001_FromC.JPG.

FIG. 3 also shows the states of files owned by camera B when cameras A and B execute synchronous processing. These files undergo the same synchronous processing as in the above description. The description suffices to indicate only the states of files of one camera, and a description of the states of another camera will be omitted in the following descriptions.

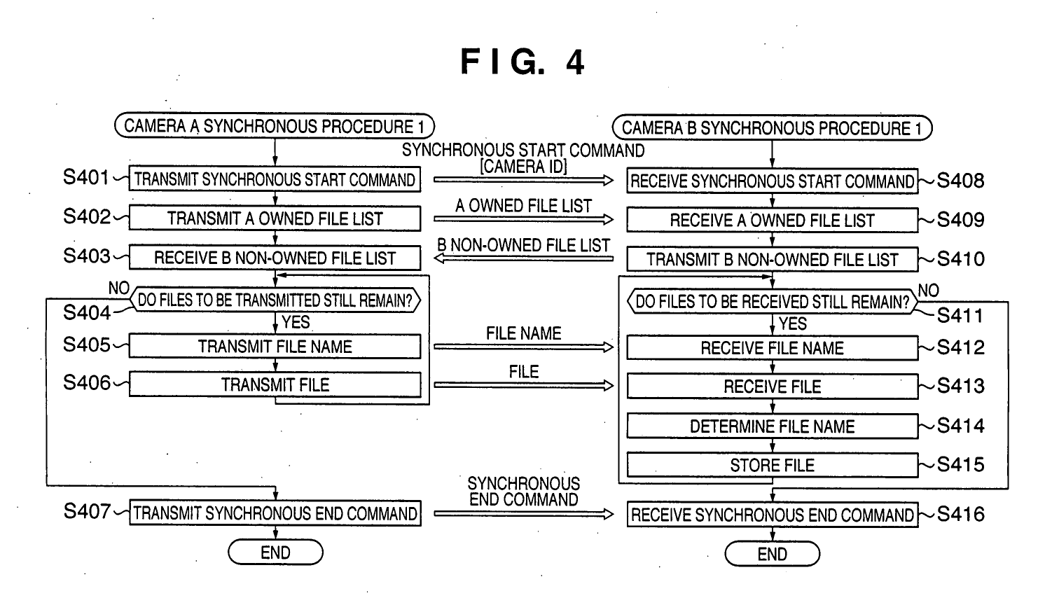

Synchronous procedure 1 between cameras A and B upon execution of the synchronous processing shown in FIG. 3 will be described below using the flowchart of FIG. 4.

Initially, when the user of camera A executes a predetermined synchronous processing operation to pass files, which are not owned by camera B, from camera A to camera B, the CPU 201 transmits a synchronous start command to camera B (step S401).

The synchronous start command contains a parameter a camera ID (in this case, “A”) as the identification number of the camera. As described above, such camera ID may be data which is freely set in camera A by the user, data which is set in producing the apparatus, or their combination. Camera B merely uses that data upon giving a name to a file.

If different cameras have the same camera ID, a problem is posed. At that time, a method of using a character string used to name a file as a new camera ID to be different from that of an old camera ID, and managing it using a correspondence table may be used. The method of using the correspondence table will be described in detail later.

Upon transmission of the synchronous start command in step S401, the CPU 201 of camera B receives this command (step S408). Assume that camera B is ready to receive this command by a predetermined operation of the user of camera B.

In the following flowcharts, the CPU 201 as the control means is almost the main body of actions. When the main body of actions is not specified, the CPU 201 is assumed to be a main body.

Camera A transmits a list of files owned by itself to camera B (step S402).

The list of owned files enumerates file names like AAAA0001.JPG, AAAA0002.JPG, and AAAA0003.JPG in the example of FIG. 3.

Upon reception of the file list in step S409, camera B returns a list of files, which are not owned by itself of those indicated by the file list, to camera A (step S410).

In the example of FIG. 3, since camera B does not own all of these three files, it returns a list of these three files.

Upon reception of the non-owned file list of camera B in step S403, camera A transmits files in the non-owned file list to camera B in loop processes from step S404 to step S406.

In this case, a file name of a file to be transmitted is transmitted per file (step S405), and the contents of that file are then transmitted (step S406).

On the other hand, since camera B transmits the non-owned file list to camera A, and it recognizes the number of files to be received from file A, a loop is repeated from step S411 to step S415 in correspondence with the number of files to be received.

In synchronism with file transmission from camera A, a file name is received first (step S412), and the contents of the file are then received (step S413).

It is noted that FIG. 4 does not show a step of notifying the length of the file contents and/or the end of the file contents to camera B in order to inform the end of transmission of each file content to camera B. However, the descriptions of such communication manner will be omitted because it is a common practice in the communication protocol.

Next, camera B determines a name upon storing the file of interest in the FlashROM 209 on the basis of the file name received in step S412 (step S414). In this case, according to FIG. 3, if the received file name is AAAA0001.JPG, AAAA0001_FromA.JPG is determined.

The file received in step S413 is stored with the name AAAA0001_FromA.JPG under the directory /DCIM/999GIVEN (a directory separator is indicated by “/”) of the FlashROM 209 (step S415). If no such directory is present, it is created before step S415 (not shown). Upon completion of transmission of all the files, as described above, camera A transmits a synchronous end command to camera B (step S407), thus ending the processing.

If camera B receives the synchronous end command (step S416), the processing ends.

Upon reception of the synchronous end command, camera B can detect the end of synchronous processing. Hence, the end of file reception may be judged based on whether or not the synchronous end command is received, in place of step S411.

The procedure of the synchronous processing of files owned by camera A to camera B has been explained using FIG. 4. Conversely, upon executing the synchronous processing of files owned by camera B to camera A, the positions of cameras A and B in the flow of FIG. 4 can be inverted.

When the synchronous processing from camera B to camera A is executed after that from camera A to camera B, mutual synchronous processing between cameras A and B can be realized.

In the example of FIG. 4, the synchronous processing of all files owned by camera A in FIG. 3 is executed. However, some of files may be selected. That is, one or a plurality of files are selected in advance by a predetermined operation. These selected files are listed up in the owned file list of camera A. Non-selected files are not listed up in the file list.

In this manner, camera A can limit files to be passed to camera B.

Note that a directory may be selected in place of files. In FIG. 3, image files are stored under only the directory 100AAAAA in FIG. 3. However, if image files are stored under a plurality of directories, one or a plurality of directories may be selected from them. Also, combinations of files and directories may be selected.

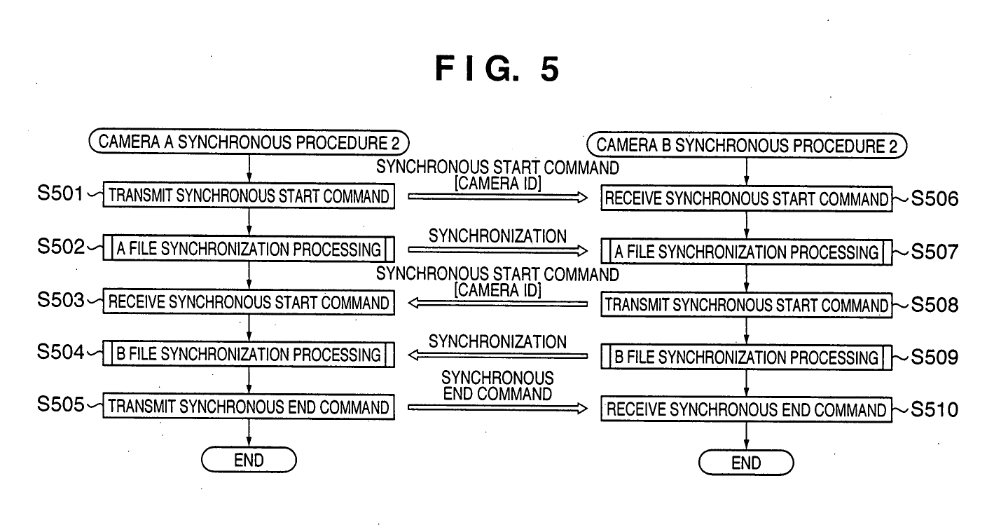

Another example (synchronous procedure 2) of the mutual synchronous procedure between cameras A and B will be described below using the flowchart of FIG. 5.

Referring to FIG. 5, when the user of camera A executes a predetermined synchronous processing operation, camera A transmits a synchronous start command to camera B (step S501).

At that time, camera B receives the synchronous start command (step S506).

Next, camera A executes synchronous processing for files owned by itself (step S502). This processing corresponds to processes in steps S402 to S406 in FIG. 4.

In synchronism with the synchronous processing, camera B also executes synchronous processing (step S507). This processing corresponds to processes in steps S409 to S415 in FIG. 4.

Then, camera B transmits a synchronous start command to camera A (step S508). At that time, “B” is set as the camera ID as a parameter of the synchronous start command. Camera A receives this synchronous start command (step S503).

Next, camera B executes synchronous processing of files owned by itself to camera A (steps S509 and S504). The relationship of steps S502 and S507 is reversed.

Finally, camera A transmits a synchronous end command to camera B (steps S505 and S510), thus ending the processing.

As described above, the sequence shown in FIG. 5 executes synchronous processing between cameras A and B at once, and the sequence in FIG. 4 need not be repeated twice. That is, the operation for starting the synchronous processing need only be done once. Also, the transmission end command need only be transmitted once.

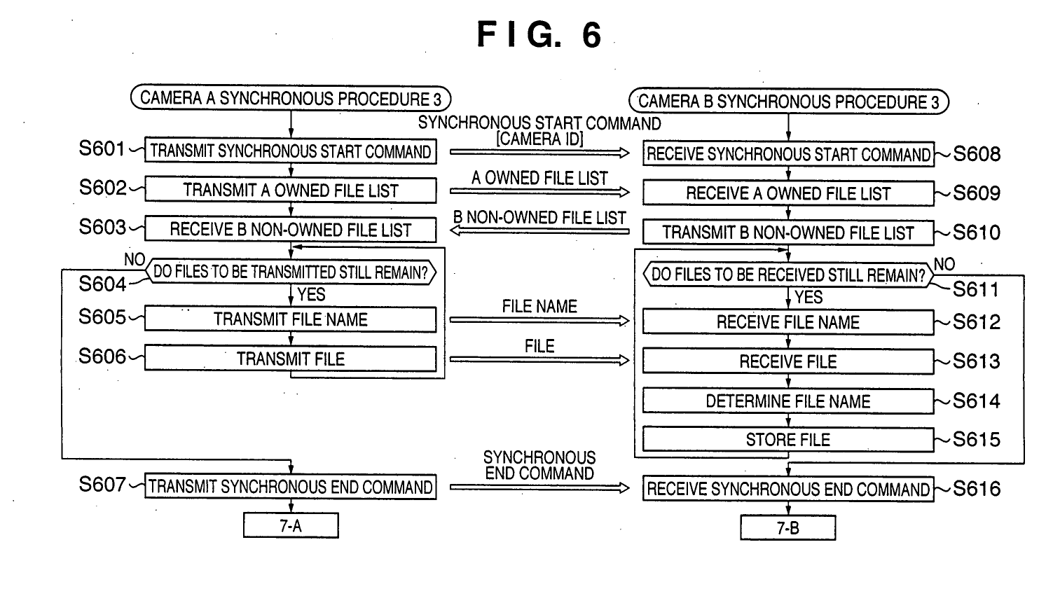

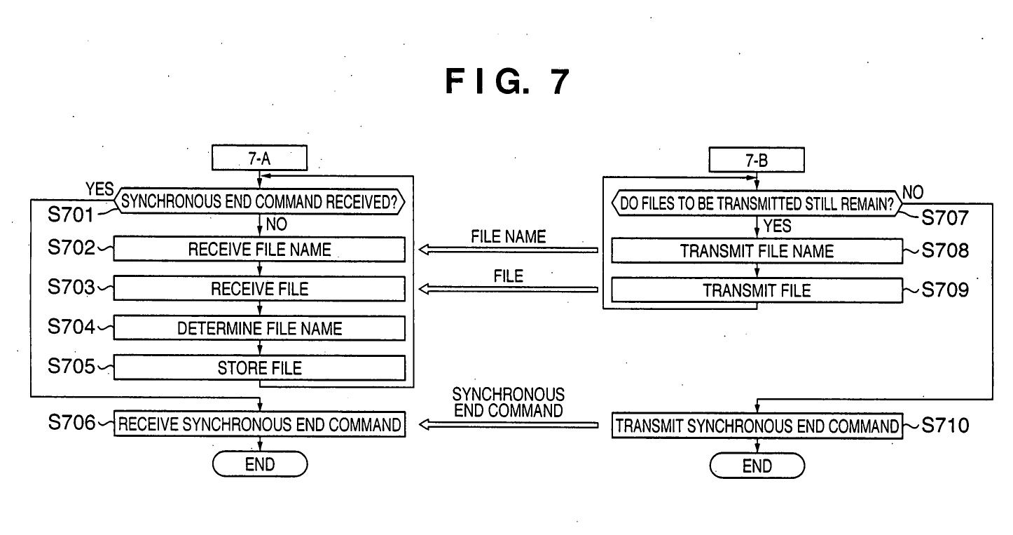

Synchronous procedure 3 between cameras A and B will be described below using the flowcharts of FIGS. 6 and 7.

Steps S601 to S607 and steps S608 to S616 in FIG. 6 are the same as steps S401 to S407 and steps S408 to S416 in FIG. 4, and the synchronous processing from camera A to camera B is completed by the processes executed so far.

At this time, camera B recognizes files to be sent to camera A. This is because camera B receives the list of files owned by camera A in step S609, and can recognize files which are not owned by camera A but are owned by camera B.

Hence, camera B transmits these files to camera A in a loop of steps S707 to S709 in FIG. 7.

On the other hand, camera A receives the transmitted files in a loop of steps S701 to S705.

If camera B sends a synchronous end command to camera A (steps S710 and S706), the processing ends.

With this procedure, the file lists need only be transmitted twice in place of four times upon executing the synchronous processing between cameras A and B.

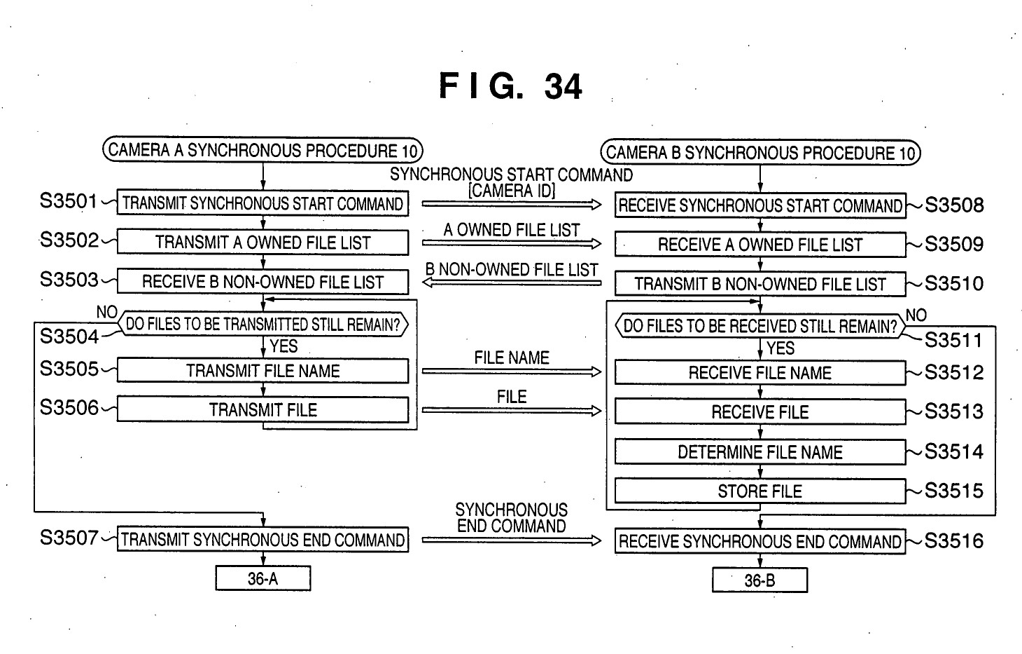

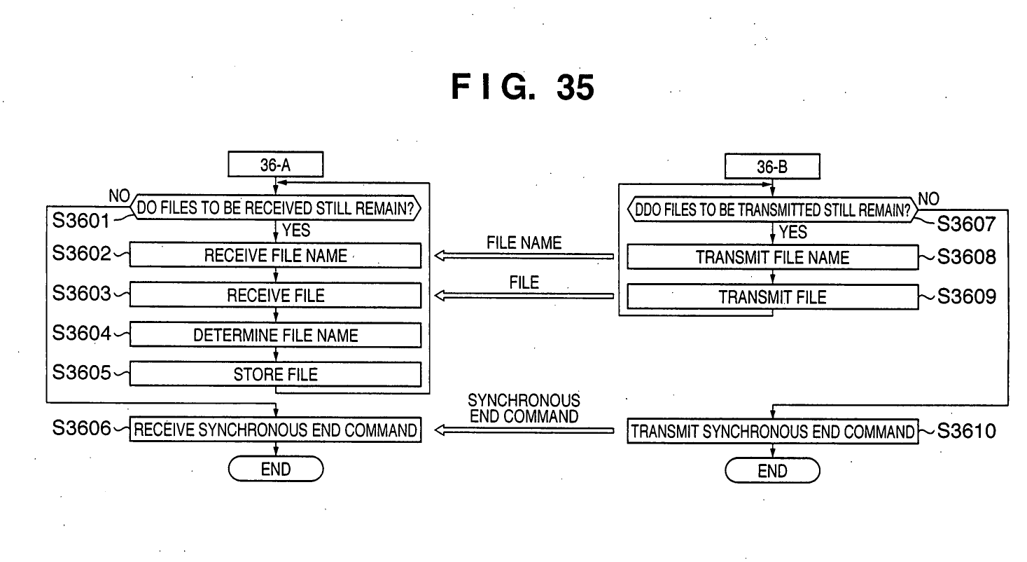

Synchronous procedure 10 between cameras A and B will be described below using the flowcharts of FIGS. 34 and 35.

The flow in FIGS. 34 and 35 is substantially the same as that in FIGS. 6 and 7, except for three steps. That is, in place of transmission of the non-owned file list from camera B in step S610, camera B transmits the owned file list in step S3510. That is, camera B transmits the owned file list of itself irrespective of the owned file list of camera A received in step S3509. With this list, camera A can calculate files to be transmitted by itself using (a∩b′) (where a is a set of files indicated by the A owned file list, b is a set of files indicated by the B owned file list, ∩ is a symbol indicating a product set, and ′ is a symbol indicating a complementary set). Camera A transmits files calculated by this operation to camera B in step S3506.

On the other hand, camera B can calculate files to be transmitted by itself using (b∩a′). Camera B transmits files calculated by this operation to camera A in step S3609.

In this manner, as in synchronous procedure 3 (FIGS. 6 and 7), the file lists need only be transmitted twice in place of four times upon executing the synchronous processing between cameras A and B.

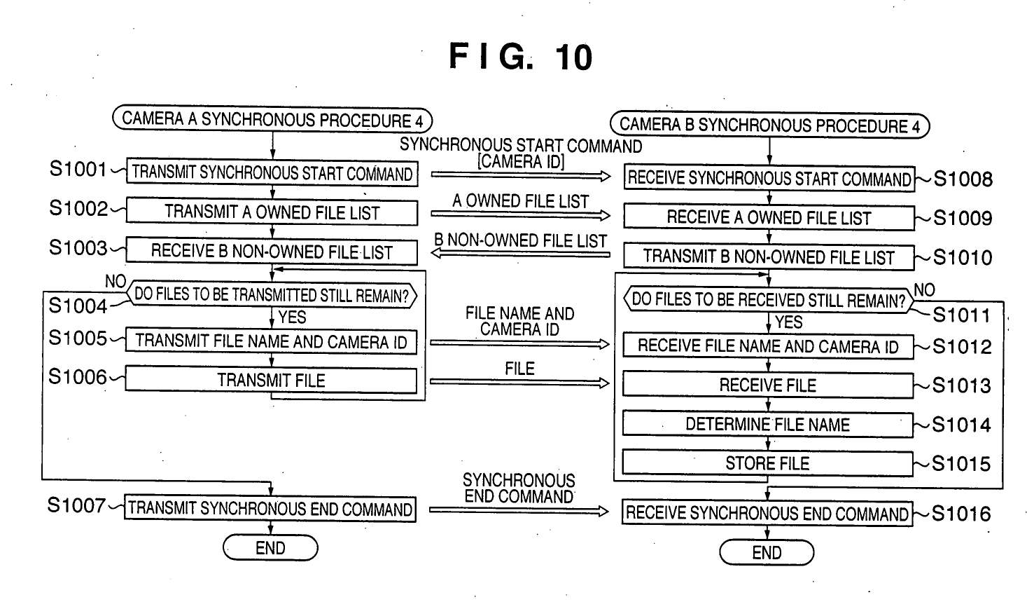

Synchronous procedure 4 executed when a file list includes a camera ID in addition to file names will be described below using the flowchart of FIG. 10.

Initially, when the user of camera A performs a predetermined operation, camera A transmits a synchronous start command to camera B (steps S1001 and S1008).

Next, camera A transmits the owned file list (steps S1002 and S1009).

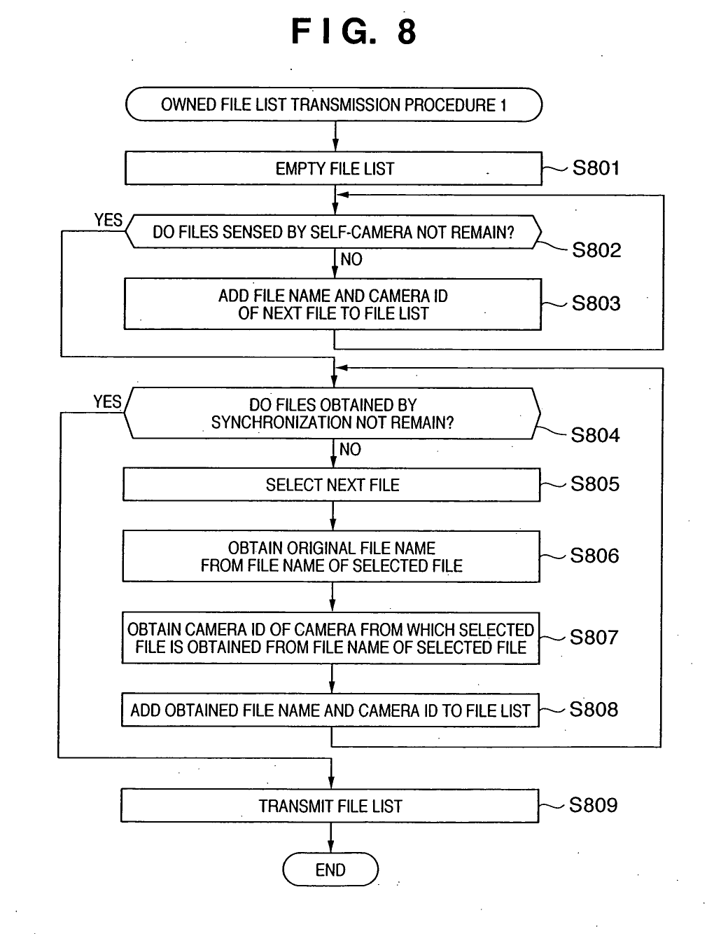

Details of transmission procedure 1 upon transmitting the owned file list from camera A will be described below using the flowchart of FIG. 8.

Initially, a file list is emptied (step S801).

Next, it is checked if files sensed by the self-camera do not remain (step S802). If sensed files still remain, the next file is selected, and the file name of that file and the camera ID of the self-camera are added to the file list (step S803).

After that, the flow returns to step S802 to process all the files sensed by itself.

Note that all of files selected in advance may be added to the file list, as described above, in place of processing all the files sensed by the self-camera.

Upon completion of the processing for all the files sensed by the self-camera, it is checked in turn if files obtained by the synchronous processing with another camera do not remain (step S804).

If files obtained by the synchronous processing still remain, the next file is selected (step S805), and an original file name is reconstructed from the selected file (step S806).

For example, in the states of files owned by camera A after synchronous processing in FIG. 3, this processing obtains the file name BBBB0001.JPG from the file name BBBB0001_FromB.JPG.

Next, the camera ID of the camera from which that file is obtained is obtained based on the file name of the selected file (step S807). In case of the file with the file name BBBB0001_FromB.JPG, this processing obtains the camera ID=B.

The file name and camera ID obtained in this way are added to the file list (step S808).

The flow returns to step S804 to repeat the processing for all the files obtained by the synchronous processing. Upon completion of the processing for all the files obtained by the synchronous processing, camera A finally transmits the file list to camera B (step S809). It seems odd that BBBB0001_FromB.JPG which is to be owned by camera B is added to the file list to be transmitted to camera B. However, the same procedure is applied to another camera (e.g., camera C). As will be described later, if camera B has already deleted and lost BBBB0001_FromB.JPG, it can receive it from camera A and can recover the file.

Upon reception of the A owned file list in step S1009, camera B transmits a list of files which are not owned by itself to camera A (steps S1010 and S1003).

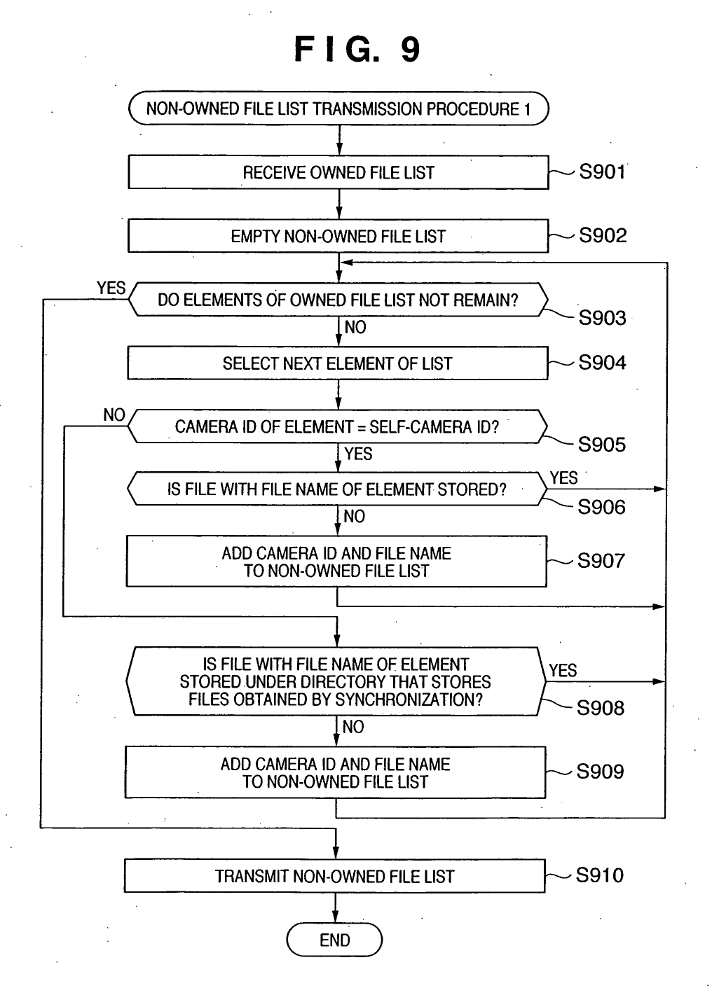

Details of transmission procedure 1 upon transmitting the non-owned file list from camera B will be described below using the flowchart of FIG. 9.

Camera B receives the owned file list from camera A (step S901). This corresponds to step S1009.

A non-owned file list is emptied (step S902).

It is checked if all elements in the owned file list of camera A received in step S901 have been processed, i.e., if elements to be processed in the list still remain (step S903).

If elements to be processed in the list still remain, the next element of the list is selected (step S904). The element of the list includes the file name and camera ID added to the list by camera A in step S808.

It is checked if the camera ID of that element is that of the self-camera (step S905).

If the camera ID is the self-camera ID, it is checked if the self-camera has a file with the file name of the selected element (step S906). If the self-camera has that file, the flow returns to step S903; otherwise, the camera ID and file name are added to the non-owned file list (step S907), and the flow then returns to step S903. As described above, the file which has already been lost can be received from camera A with this procedure. If the camera does not have that file but the file is not wanted, the file need not be added to the non-owned file list.

If it is determined in step S905 that the camera ID of the element is not the ID of the self-camera, it is checked if a file with the file name of the element is stored under the directory that stores files obtained by the synchronous processing (e.g., 999GIVEN in the example of FIG. 3) (step S908). If such file is stored, the flow returns to step S903; otherwise, the camera ID and file name of the element of interest are added to the non-owned file list (step S909), and the flow then returns to step S903.

Upon completion of the processing for all the files in the owned file list of camera A, camera B transmits the non-owned file list to camera A (step S910).

Upon reception of the B non-owned file list in step S1003, camera A transmits, to camera B, the file name and camera ID described in the file list in correspondence with each of files to be transmitted (steps S1005 and S1012).

After that, camera A transmits the contents of the file to camera B (steps S1006 and S1013).

Camera B determines a file name of the file to be stored in the FlashROM 209 on the basis of the file name and camera ID received in step S1012 (step S1014). Camera B stores the file with the determined file name in the FlashROM 209 (step S1015), and the processing ends via transmission/reception of a synchronous end command (steps S1007 and S1016).

As described above, since the file list includes the file names and camera IDs, the synchronous processing can be done as if self-camera had the files that are really owned by another camera. However, the files do not completely become the possession of self-camera, because the ID of the camera which senses the image file is held.

Therefore, for example, when synchronous processing is executed between cameras A and B, and is then executed between cameras A and C, and files of camera B are sent to camera C, since camera C can recognize that these files are sensed by camera B, camera B never sends files already owned by camera C when synchronous processing is finally executed between cameras C and B.

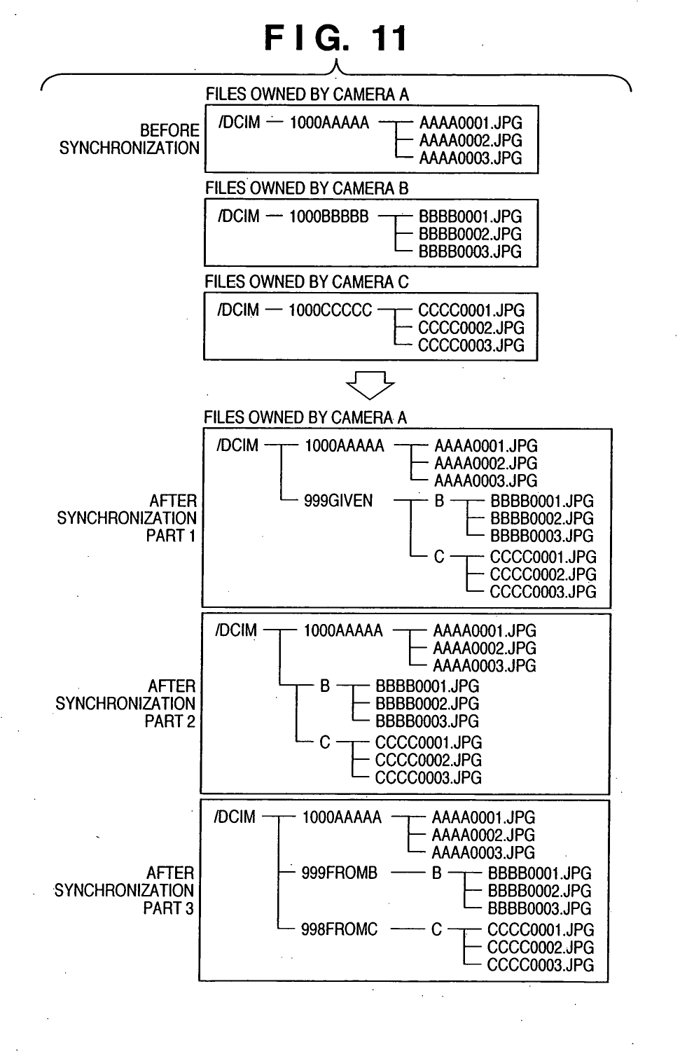

An embodiment when files obtained from another camera by synchronous processing for respective cameras using directories will be described below using FIG. 11.

Assuming that files owned by cameras A, B, and C before synchronization are as shown in FIG. 11, three different methods shown in FIG. 11 can be used as a method which allows camera A to manage files obtained from another camera by the synchronous processing for respective cameras using directories.

In an example indicated by “after synchronization part 1”, files obtained from another camera are stored under the directory 999GIVEN. Speaking in more detail, immediately under 999GIVEN, directories indicating the camera IDs as synchronization partners are made, and files obtained by the synchronous processing are stored under these directories.

In an example indicated by “after synchronization part 2”, the directory 999GIVEN that stores files obtained from another camera is not made, and directories indicating the camera IDs as synchronization partners are made immediately under the directory DCIM, and files obtained by the synchronous processing are stored under these directories.

In an example indicated by “after synchronization part 3”, directories which indicate the camera IDs as synchronization partners and have names defined by three digits of numerals+“FROM”+camera ID, are made immediately under the directory DCIM, and files obtained by the synchronous processing are stored under these directories.

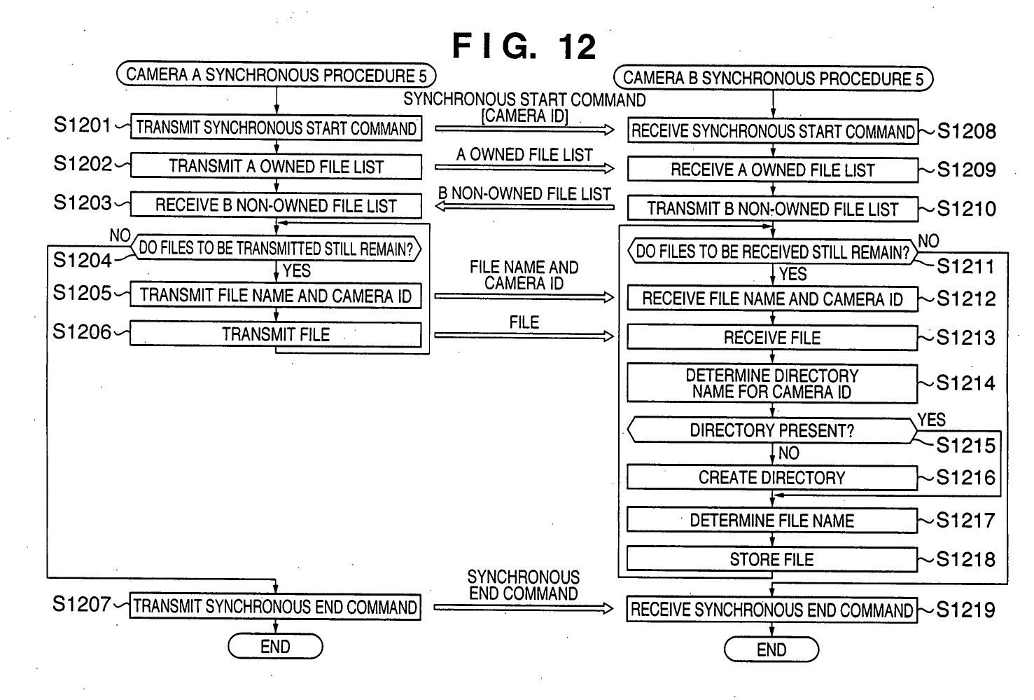

Synchronous procedure 5 between cameras A and B will be described below using the flowchart of FIG. 12.

Processes from step S1201 to step S1213 are the same as those from step S1001 to step S1013 in FIG. 10 (more specifically, the owned file list transmission procedure (step S1202) and non-owned file list transmission procedure (step S1210) are different from the aforementioned procedures, and they will be described later).

After the file is received in step S1213, camera B determines a directory name for the camera ID received in step S1212 (step S1214).

For example, according to “after synchronization part 1” in FIG. 11, a directory name /DCIM/999GIVEN/A is determined. The same applies to “after synchronization part 2 and part 3”.

If no directory with the determined directory name is present (step S1215), that directory is created (step S1216). If that directory is present, the creation step is skipped.

Next, a file name upon storage is determined (step S1217). However, since the camera ID has already been distinguished by the directory, it need not be added to the file name, and the file name obtained in step S1212 is used intact.

The processes after file storing (step S1218) are the same as those in FIG. 10.

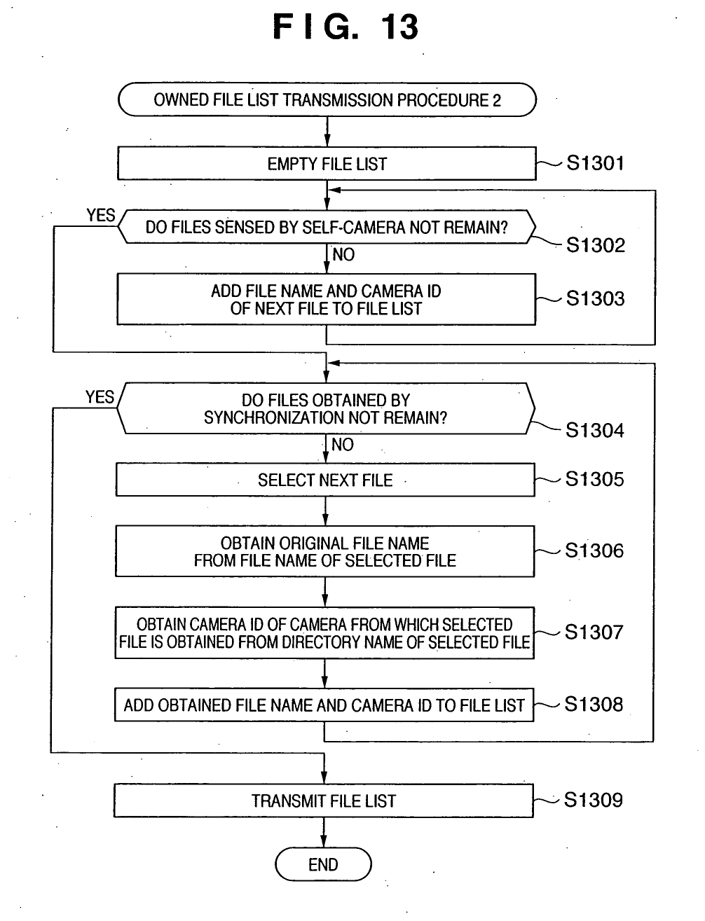

Transmission procedure 2 of the owned file list by camera A in step S1202 in FIG. 12 will be described below using the flowchart of FIG. 13.

The procedure in FIG. 13 is common to that in FIG. 8, except that only step S1307 is different from step S807.

In step S1307, the camera ID of a camera from which a selected file is got is obtained from the name of a directory in which the file is stored. In any of “after synchronization part 1, 2, or 3” in FIG. 11, the camera ID can be obtained by the step.

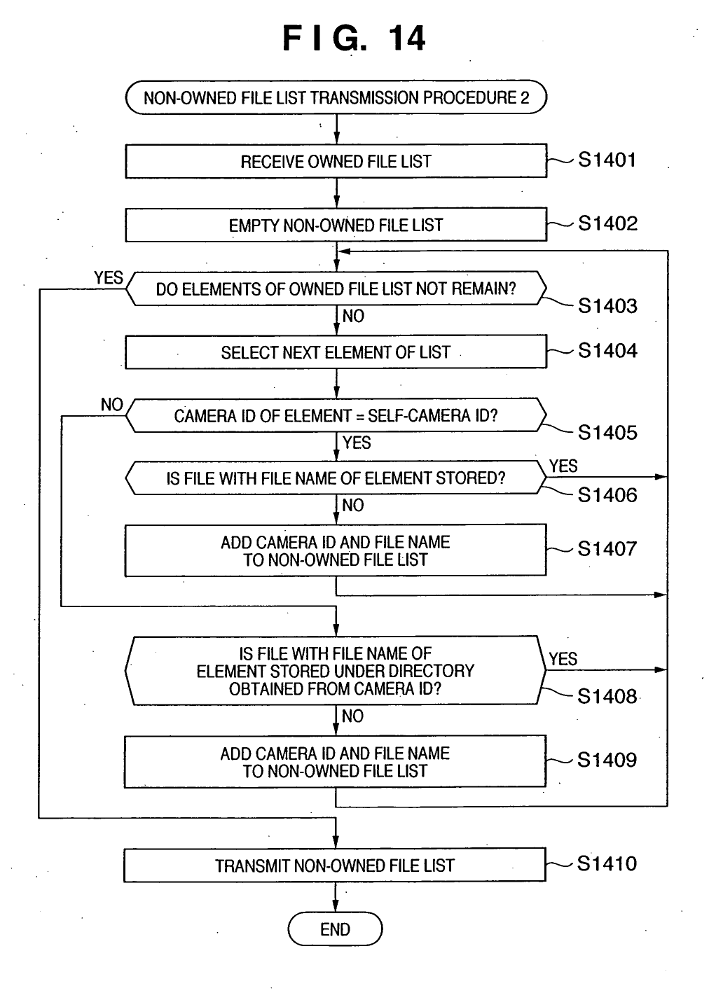

Transmission procedure 2 of the non-owned file list by camera B in step S1210 in FIG. 12 will be described below using the flowchart of FIG. 14.

The procedure in FIG. 14 is common to that in FIG. 9, except that only step S1408 is different from step S908.

It is checked in step S1408 if a file with the file name of the element selected in step S1404 is stored under the directory obtained from the camera ID of the selected element. In this case as well, the directory obtained from the camera ID of the element can be obtained like in “after synchronization part 1, 2, or 3” in FIG. 11.

As has been explained above using FIGS. 11 to 14, since files obtained from a synchronization partner are stored under a directory obtained based on the camera ID, their file names need not be changed. If an original file name complies with the 8.3 format, the stored file has that file name. If the directory name determined based on the camera ID is also short, it can comply with the 8.3 format, and can also comply with the rule of the DOS FAT file system (DOS indicates Disk Operating System such as MS-DOS or the like; MS-DOS is the registered trade name of Microsoft Corporation in U.S.A. and other countries).

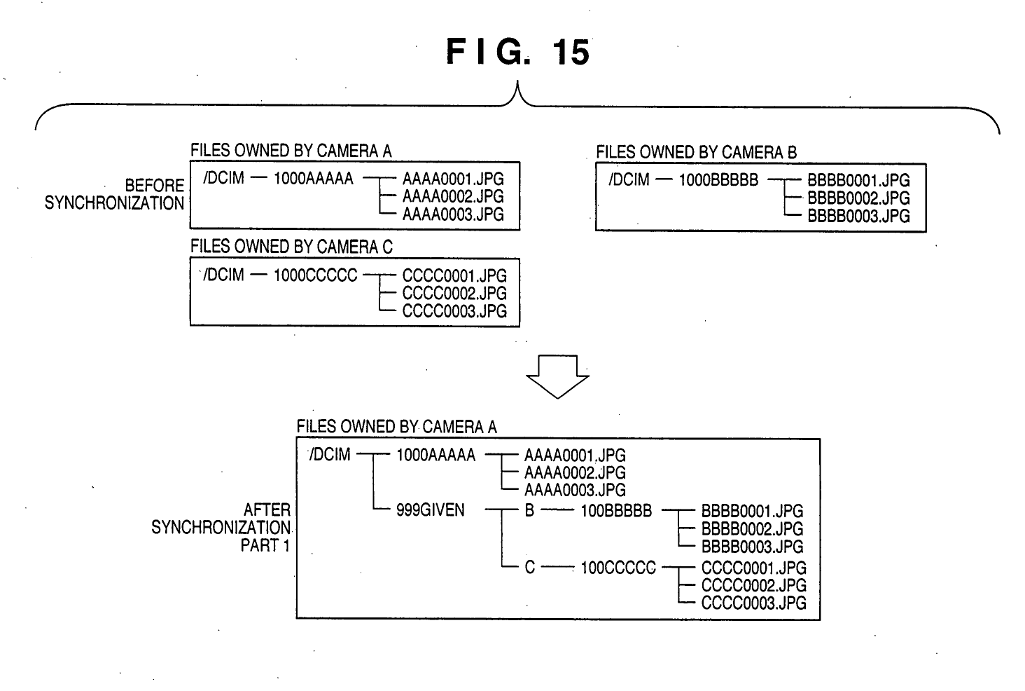

An embodiment when files obtained from another camera by synchronous processing are to be managed for respective cameras using directories, and the directory paths of files stored in another camera are held will be described using FIG. 15.

In this embodiment, assuming that files owned by cameras A, B, and C before synchronization are as shown in FIG. 15, after cameras A and B execute synchronous processing, and cameras A and C then execute synchronous processing, the state of the file system is as shown in “after synchronization part 1” in FIG. 15.

That is, directories indicating the camera IDs are made immediately under the directory 999GIVEN, and the same directories as those held under the directory DCIM by another camera are made under these directories. Then, files obtained from another camera are stored under these directories. That is, the structure under the directory indicating each camera ID is the same as that under the directory DCIM of the camera indicated by that camera ID.

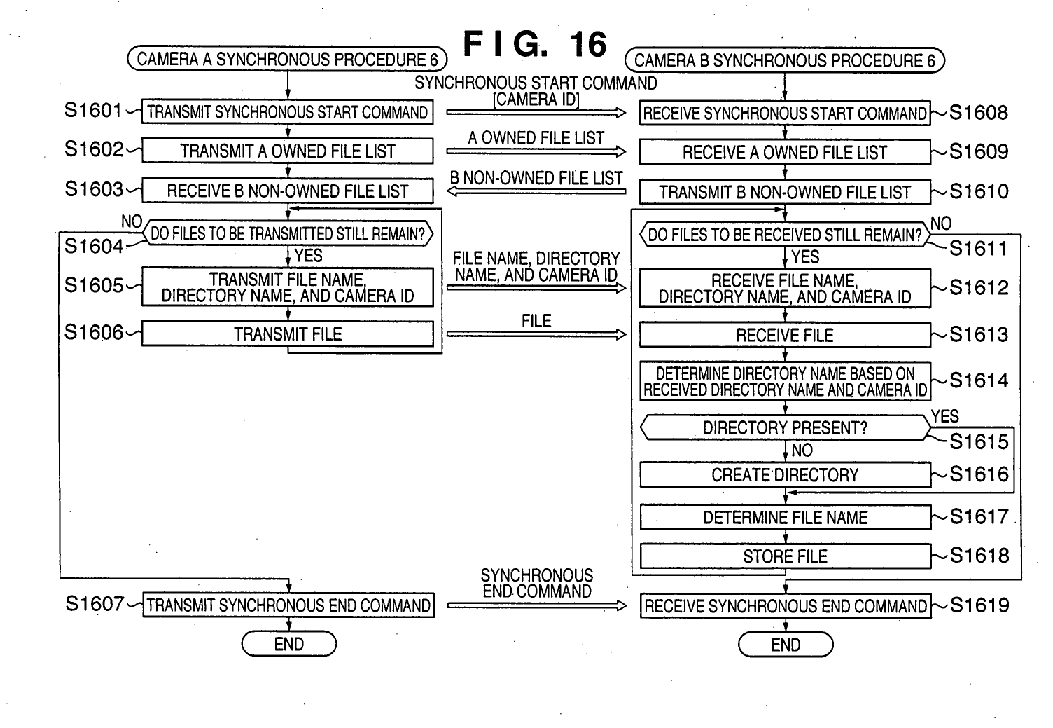

Synchronous procedure 6 upon executing the file synchronous processing shown in FIG. 15 will be described below using the flowchart of FIG. 16.

The sequence shown in FIG. 16 is common to that in FIG. 12, except for the contents of step S1602 in which camera A transmits the owned file list.

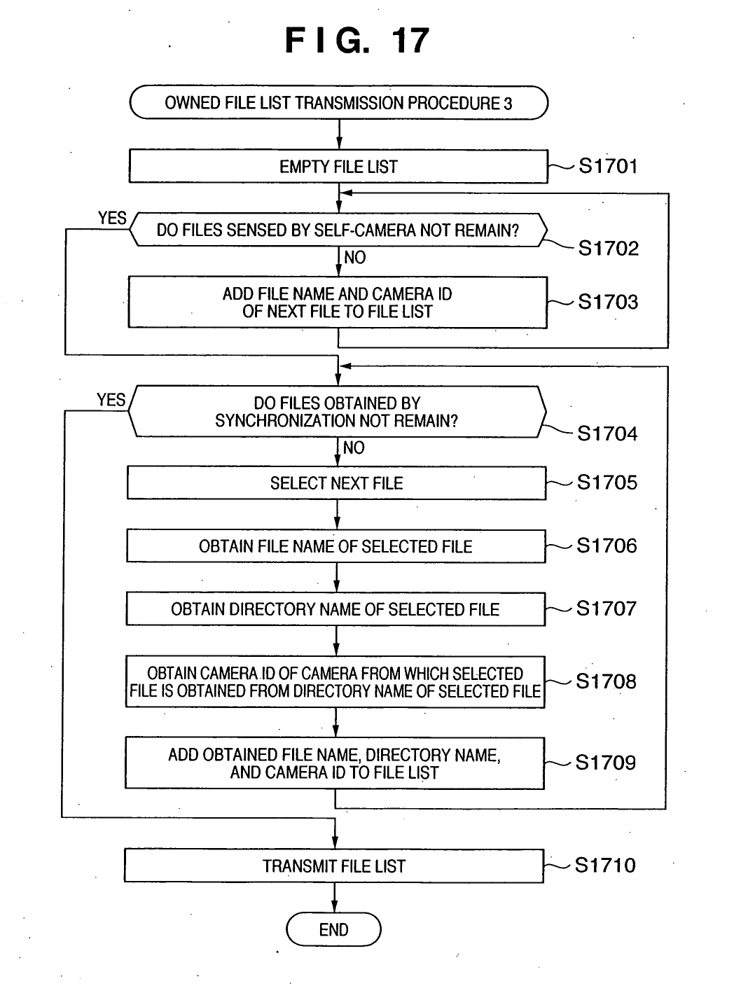

Details of transmission sequence 3 of the A owned file list in step S1602 will be described below using the flowchart in FIG. 17.

The flow until step S1705 in FIG. 17 is the same as that until step S1305 in FIG. 13.

In step S1705, the next file is selected. At this time, camera A searches for a file obtained by the synchronous processing from another camera under the directory 999GIVEN.

In step S1706, camera A obtains the file name of the file selected in step S1705.

Next, the directory name in which the selected file is stored is obtained (step S1707). To be more precise, the directory name to be obtained is the name of a directory under the directory indicated by the camera ID. For example, in the state of the file system of “after synchronization part 1” in camera A of FIG. 15, and in case of CCCC0001.JPG as the selected file, “100CCCCC” is the directory name to be obtained in step S1707.

The camera ID of the camera from which the selected file is obtained is obtained on the basis of the directory name in which the selected file is stored (step S1708). In the above example, the camera ID “C” is obtained from the parent directory name of the directory 100CCCCC.

The obtained file name, directory name, and camera ID are added to the file list (step S1709), and the completed file list is finally transmitted to camera B (step S1710).

In FIG. 16, camera B transmits the non-owned file list in step S1610.

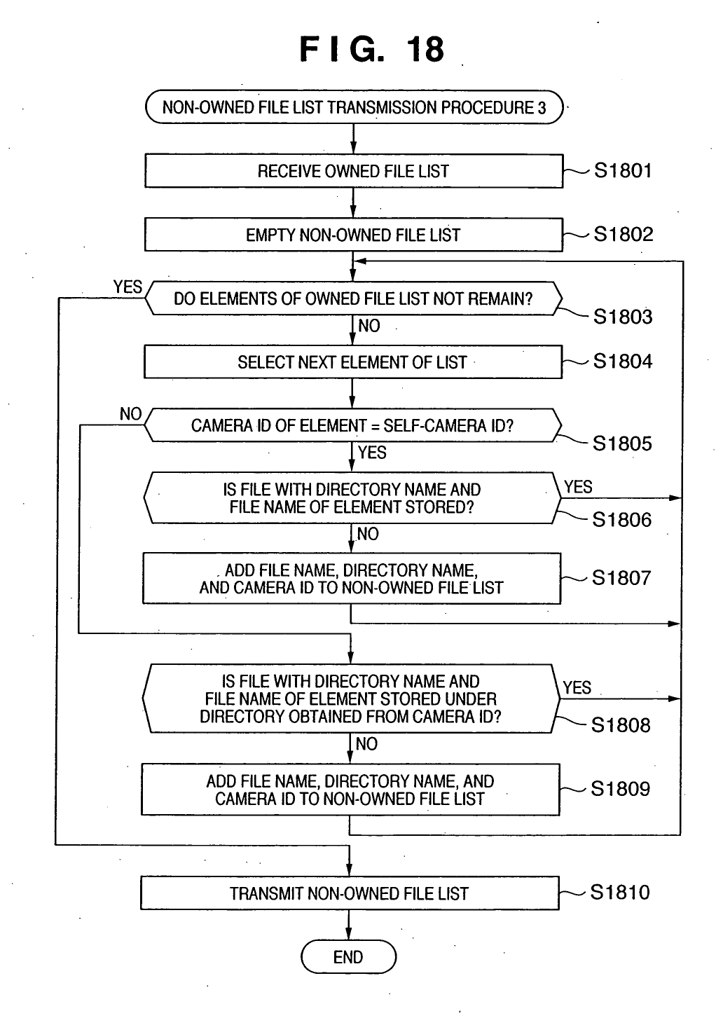

Details of transmission procedure 3 of the B non-owned file list in step S1610 will be described below using the flowchart of FIG. 18.

The flow until step S1803 in FIG. 18 is the same as that until step S1403 in FIG. 14.

In step S1804, the next element is selected from the A owned file list received in step S1801.

Since this file list is generated based on the sequence in FIG. 17, the element of the file list includes the file name, directory name, and camera ID.

It is checked if the camera ID of the element is the self-camera ID (step S1805). If the camera ID of the element is the self-camera ID, it is checked if a file having the directory name and file name of the element is stored (step S1806).

If such file is stored, the flow returns to step S1803; otherwise, the file name, directory name, and camera ID of the element of interest are added to the non-owned file list (step S1807).

If it is determined in step S1805 that the camera ID of the element is not the self-camera ID, it is checked if a file with the directory name and file name of the element (e.g., a file with the directory name 100CCCCC and file name CCCC0001.JPG in FIG. 15) is stored under the directory (e.g., directory C in the example of FIG. 15) obtained from the camera ID of the element (step S1808).

If such file is stored, the flow returns to step S1803; otherwise, the file name, directory name, and camera ID of the element of interest are added to the non-owned file list (step S1809).

Upon completion of the processing for all the elements in the owned file list, the non-owned file list is transmitted to camera A (step S1810).

Referring back to FIG. 16, camera A receives the B non-owned file list in this way (step S1603).

Camera A transmits the file name, directory name, and camera ID for each of files in that B non-owned file list to camera B (steps S1605 and S1612). After that, camera A transmits the contents of the file (steps S1606 and S1613).

Camera B determines a directory name upon storing the received file on the basis of the received directory name and file name (step S1614).

In the example of FIG. 15, in case of the directory name 100CCCCC, file name CCCC0001.JPG, and camera ID “C”, the name of a directory that stores this file is determined as C/100CCCCC.

If it is checked if the determined directory is present (step S1615). If no such directory is present, the directory is created (step S1616). In the above example, a directory C is created first, and a directory 100CCCCC is then created under the directory B.

The processes in step S1617 and the subsequent steps are the same as those in step S1217 and the subsequent steps in FIG. 12.

With the processing shown in FIGS. 15 to 18, the synchronous processing can be executed while holding the directory structures of another camera. As a result, even when another camera has a file with the same name under a different directory, synchronous processing can be correctly executed.

For example, assume that camera B has a file 100BBBBB/BBBB0001.JPG. When synchronous processing is executed from camera B to camera A, this file is sent to camera A. Next, assume that a file 100BBBBB/BBBB0001.JPG is added to camera B. When synchronous processing is executed from camera B to camera A again, the file 101BBBBB/BBBB0001.JPG is also stored in camera A. In camera A, the file 100BBBBB/BBBB0001.JPG is stored intact without being overwritten. At this time, when synchronous processing is executed from camera A to camera C, both the two files undergo the synchronous processing.

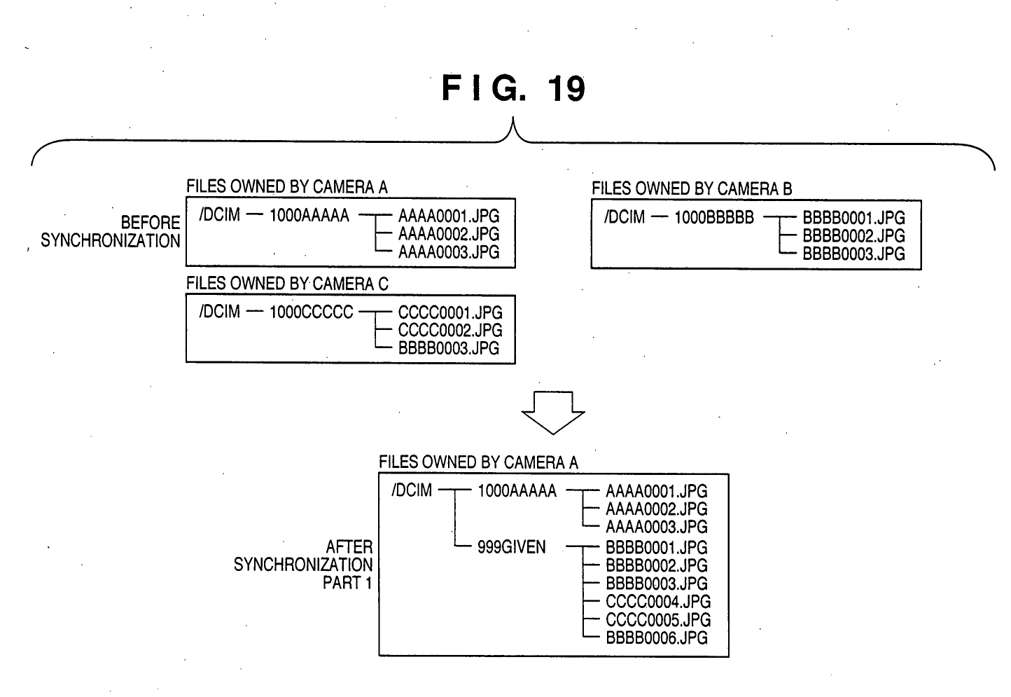

An embodiment when files after synchronization are written in a storage medium in the DCF compatible format will be described below using FIG. 19.

FIG. 19 shows the state of the file system of camera A after cameras A and B execute synchronous processing and cameras A and C then execute synchronous processing.

Files owned by cameras B and C are stored under the common directory 999GIVEN. “999GIVEN” is selected to comply with the DCF directory rule (i.e., three numerals+five upper case characters).

Also, some of the names of files owned by cameras B and C are changed.

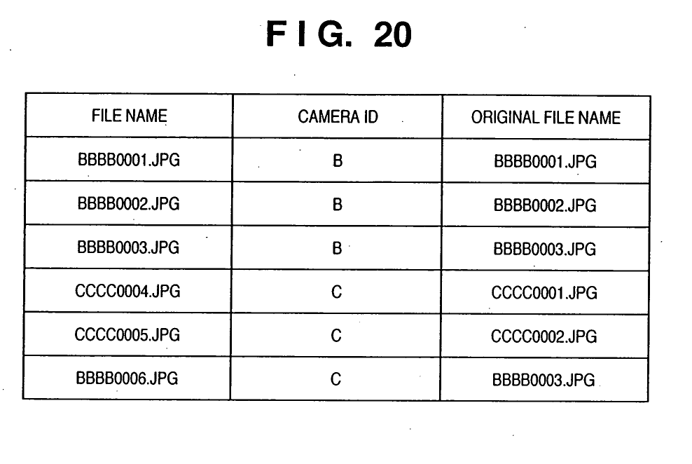

When the name of a file is changed, a table shown in FIG. 20 is used to obtain its original file name.

FIG. 20 is a table showing correspondence among the file name of a file stored under the directory 999GiVEN of camera A, the camera ID of a camera that transmitted the file, and original file name in camera B or C after synchronization.

A file name given upon storing a file obtained by the synchronous processing complies with the DCF file name rule (a file name except for an extension is defined by eight characters which includes four upper case characters+four numerals).

When the original file name complies with the DCF file name rule, and the self-camera does not have any file with that file name, the same name can be given (in an example of FIG. 20, BBBB0001.JPG).

When the original file name complies with the DCF file name rule, but the self-camera has a file with that file name (corresponding to BBBB0003.JPG of camera C when camera A executes synchronous processing with camera B and then executes synchronous processing with camera C), or the self-camera has a file which has the same file name number, i.e., the same lower four numerals in the file name (corresponding to CCCC0001.JPG in FIG. 20 when camera A executes synchronous processing with camera B and then executes synchronous processing with camera C), the name of a file to be stored is determined according to the DCF rule.

The table shown in FIG. 20 is created by the CPU 201 of camera A, and is stored in the RAM 203. Alternatively, the table is stored as a file on the FlashROM 209 in preparation for power OFF.

As the synchronous processing procedure using FIGS. 19 and 20, for example, the sequences shown in FIGS. 8, 9, and 10 are used.

In order to search for files sensed by the self-camera in step S802, the search processing starts from a directory which stores files sensed by the self-camera. In this embodiment, if the directory number indicated by the upper three numerals of the DCF directory name is a lower number incremented from 100, it is determined that the directory stores files sensed by the self-camera. On the other hand, in order to search for files obtained by the synchronous processing in step S804, the search processing starts from a directory which stores files obtained by the synchronous processing. In this example, if the DCF directory number is a higher number decremented from 999, it is determined that the directory stores files obtained by the synchronous processing.

The original file name can be easily reconstructed from the file name of the selected file in step S806 using the table in FIG. 20.

The same applies to step S807 of obtaining the camera ID.

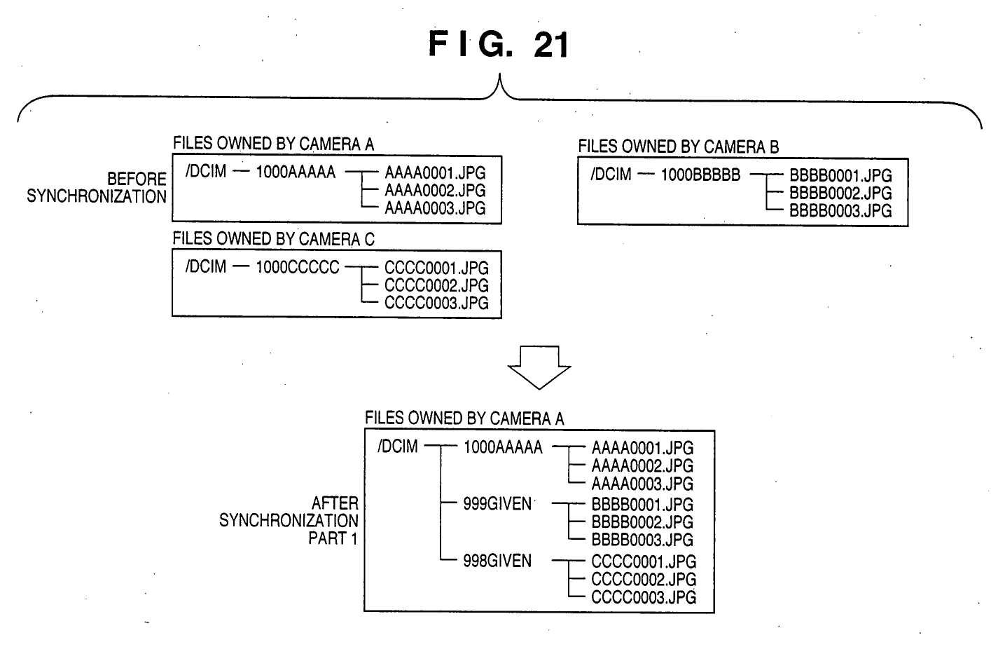

An embodiment when files after synchronization are written in a storage medium in the DCF compatible format, DCF directories are created for respective cameras as synchronous partners, and files obtained by the synchronous processing are stored under these directories will be described below using FIG. 21.

FIG. 21 shows the state of the file system when camera A executes synchronous processing with cameras B and C.

Files owned by camera B are stored under a directory 999GIVEN. Files owned by camera C are stored under a directory 998GIVEN. When camera A executes synchronous processing a new synchronous partner, a directory name decremented from the DCF directory number “999” is used.

Since the directory names which are not related to the camera IDs are used, the CPU 201 must store correspondence between the directory names and camera IDs.

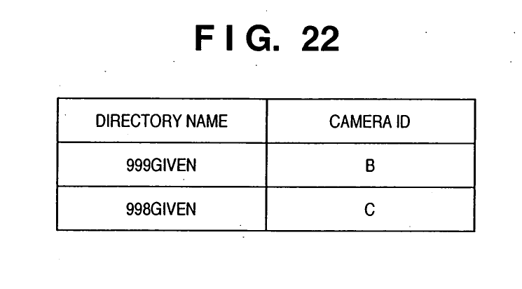

A table shown in FIG. 22 is used in this case. This table is stored in the RAM 203. Alternatively, this table is stored as a file on the FlashROM 209 in preparation for power OFF.

As the synchronous processing procedure using FIGS. 21 and 22, for example, the sequences shown in FIGS. 13, 14, and 28 are used.

In the process for obtaining an original file name from the file name of the selected file in step S1306, since the file name is not changed upon storage, it can be directly used as the original file name.

The camera ID of a camera from which a selected file is got can be easily obtained on the basis of the directory name of the file in step S1307 using the table shown in FIG. 22.

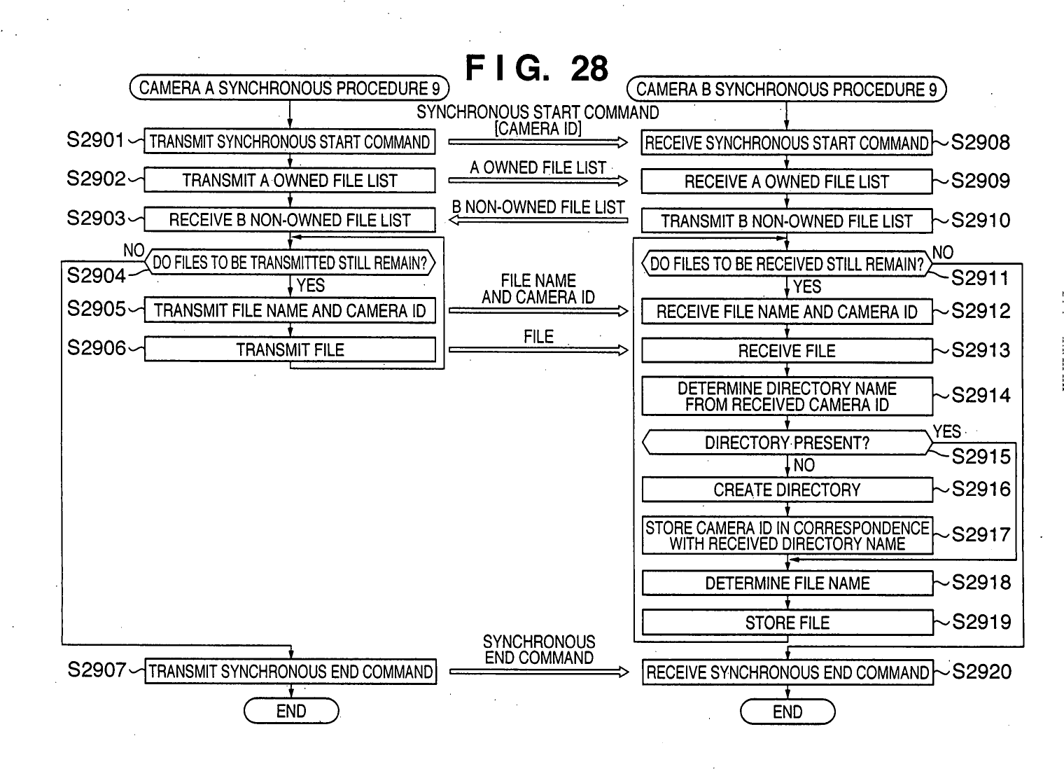

Synchronous procedure 9 from camera A to camera B when the file list transmission procedures in FIGS. 13 and 14 are used will be described below using the flowchart of FIG. 28.

Referring to FIG. 28, when the user of camera A performs a predetermined operation initially, camera A transmits a synchronous start command to camera B (steps S2901 and S2908).

Camera A transmits an owned file list according to the sequence in FIG. 13 (steps S2902 and S2909).

Upon reception of the A owned file list in step S2909, camera B transmits a list of files which are not owned by itself to camera A (steps S2910 and S2903). The transmission procedure follows the sequence in FIG. 14.

Upon reception of the B non-owned file list in step S2903, camera A transmits, to camera B, the file name and camera ID described in the file list in correspondence with each of files to be transmitted (steps S2905 and S2912).

After that, camera A transmits the contents of the file to camera B (steps S2906 and S2913).

Camera B determines a directory name based on the camera ID received in step S2912 (step S2914). For example, a directory name 998GIVEN for the camera ID “C” is determined according to the DCF directory name rule. In this case, the table shown in FIG. 22 is checked to see if a directory name has already been assigned to that camera ID. If a given directory name has already been assigned, that name is determined; otherwise, a directory name different from those which are assigned to another camera IDs is determined. More specifically, the directory number is decremented from 999, and an unassigned number is adopted. In this way, different directory names are prevented from being assigned to an identical camera ID. Also, an identical directory name is prevented from being assigned to different camera IDs.

It is checked if a directory having the directory name determined in this manner is present (step S2915).

If no such directory is present, that directory is created (step S2916).

The camera ID is stored, as shown in FIG. 22, in correspondence with the determined directory name (step S2917).

If the directory is present in step S2915, steps S2916 and S2917 are skipped.

A file name of the file to be stored in the FlashROM 209 is determined on the basis of the file name received in step S2912 (step S2918). Nevertheless, the file name received in step S2912 is used intact in this case.

The file is stored in the FlashROM 209 with the determined file name (step S2919), and the processing ends via transmission/reception of a synchronous end command (steps S2907 and S2920).

In the aforementioned embodiment, when a given camera executes synchronous processing with a new camera, a directory name with a directory number decremented from the DCF directory number “999” is used. In this manner, a directory that stores files sensed by the self-camera can be easily distinguished from directories which store files acquired from another camera by the synchronous processing.

However, such directory name determination is not indispensable.

Normally, upon image sensing using a camera, if a new directory must be created since the number of files stored in the existing directory reaches a maximum value, the maximum value of the existing DCF directory number+1 is adopted as a new DCF directory number.

The camera which complies with such specification may not recognize a DCF directory with a large directory number such as 999 or the like.

In order to solve this problem, when the directory name is determined based on the received camera ID in step S2914, if no directory name has already been assigned to that camera ID, the directory name can be determined as that includes the directory number defined by the maximum value of the existing DCF directory number+1. Of course, the camera ID is stored in the table of FIG. 22 in correspondence with the directory name determined in this way.

With this process, a file sensed by the self-camera is likely to be stored in the directory that stores synchronous files with another camera by mistake. In order to avoid such case, the self-sensed file is inhibited from being stored in the directory used in synchronous processing with another camera. It is determined whether a directory is for storing self-sensed image by checking the table shown in FIG. 22 (not shown).

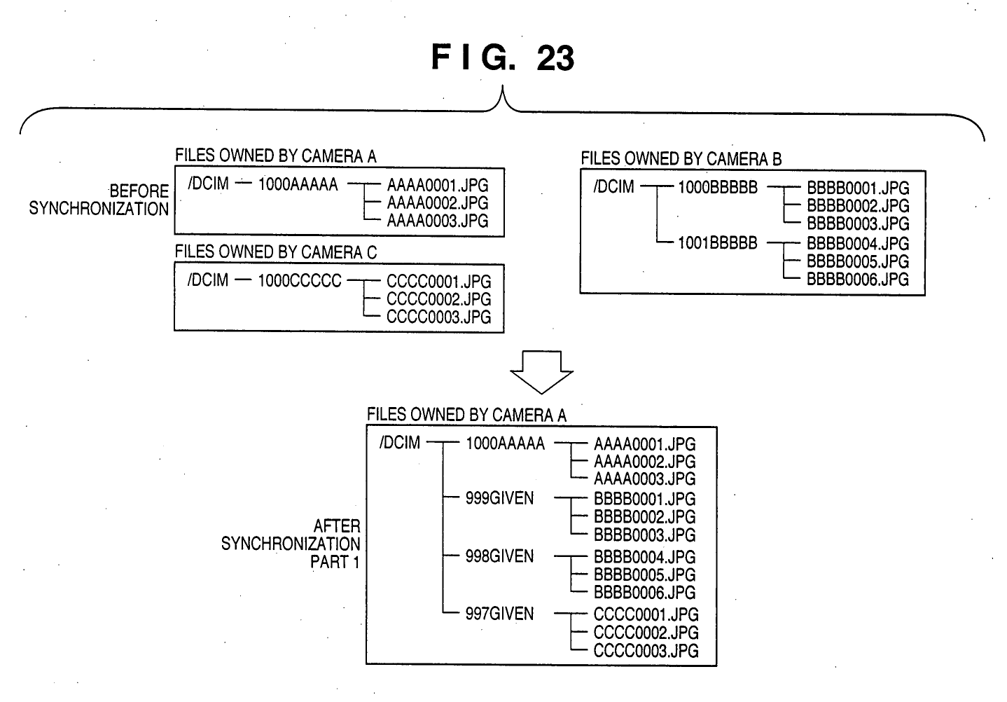

An embodiment when files after synchronization are written in a storage medium in the DCF compatible format, DCF directories are created for respective DCF directories of cameras as synchronous partners, and files obtained by the synchronous processing are stored under these directories will be described below using FIG. 23.

FIG. 23 shows the state of the file system when camera A executes synchronous processing with cameras B and C.

Those files under a directory 100BBBBB owned by camera B are put under a directory 999GIVEN. Those files under a directory 101BBBBB owned by camera B are put under a directory 998GIVEN. Those files under a directory 100CCCCC owned by camera C are put under a directory 997GIVEN. When a new directory is synchronously received (in case of a new synchronous partner, that directory is inevitably handled as a new directory), a directory name decremented from the DCF directory number “999” is used.

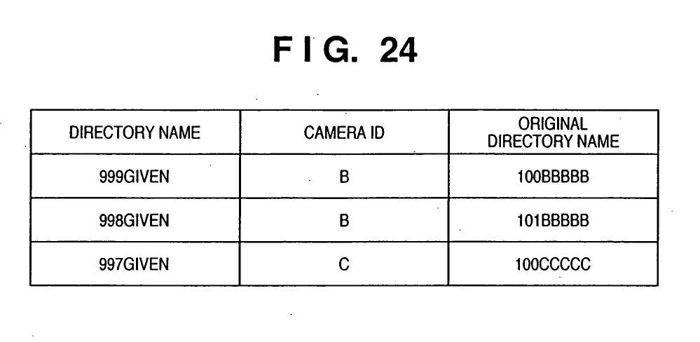

In the example of FIG. 23, the CPU 201 manages correspondence among the directory name used to store synchronous files, the camera ID, and original directory name of the synchronous partner. A table shown in FIG. 24 stores this correspondence.

As the synchronous processing procedure using FIGS. 23 and 24, for example, the sequences shown in FIGS. 16, 17, and 18 are used.

If the directory name of the selected file is to be obtained in step S1707, an original directory name is reconstructed based on the directory name where that file is stored using the table shown in FIG. 24.

The camera ID of the camera from which the selected file is got can be easily obtained in step S1708 from the directory name of the selected file using the table shown in FIG. 24.

In the example of FIGS. 23 and 24, a directory having a number decremented from the DCF directory number “999” is used. However, the present invention is not limited to such specific directory name. As in the above example, a directory name including a number obtained by the maximum value of the existing DCF directory number+1 may be used. In short, the directory name need only be associated with the original directory name in the table of FIG. 24.

An embodiment that executes synchronous processing by identifying files based on their creation times (in case of a sensed image file, the file creation time often equals an image sensing time) in addition to their file names will be described below.

An digital camera has a reset function of the DCF file number. When a new storage medium is used, the DCF file number is reset and starts from 0001 again. In such case, since files having the identical file names may have different contents, such files preferably undergo synchronous processing as different files.

In addition to an digital camera, since a situation in which files having identical file names may have different contents readily occurs, such situation need be coped with.

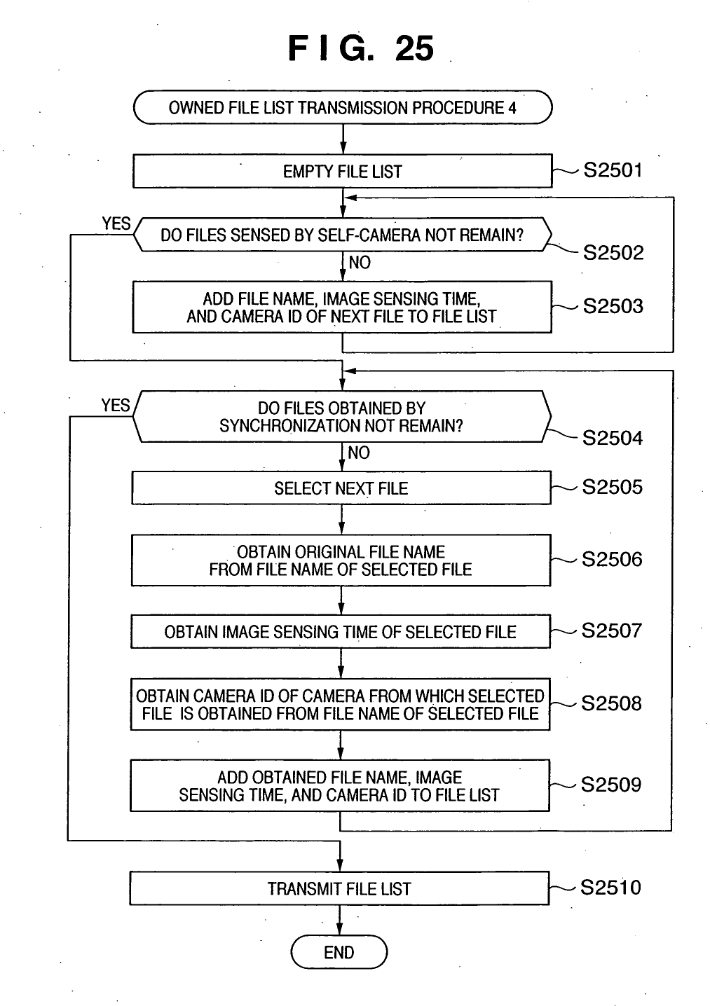

FIG. 25 is a flowchart showing owned file list transmission procedure 4 by camera A.

Referring to FIG. 25, a file list is emptied initially (step S2501).

Next, it is checked if files sensed by the self-camera do not remain (step S2502). If sensed files still remain, the next file is selected, and the file name and image sensing time of that file and the camera ID of the self-camera are added to the file list (step S2503).

If the format of the sensed image file is Exif (image file format standard Version 2.1 for digital cameras specified by JEIDA), since the image sensing time is included in the image file, it can be used as the image sensing time. Alternatively, the CPU 201 manages the image sensing time as independent data or an independent file, and such independent data or file may be used. Alternatively, as will be described later in a description of step S2715, an original file name, image sensing time, and camera ID are stored in a correspondence table (not shown) in correspondence with the file name of the file to be stored, and the image sensing time in this table may be used.

After that, the flow returns to step S2502 to process all the files sensed by itself.

Note that all of files selected in advance may be added to the file list, as described above, in place of processing all the files sensed by the self-camera.

Upon completion of the processing for all the files sensed by the self-camera, it is checked in turn if files obtained by the synchronous processing with another camera do not remain (step S2504).

If files obtained by the synchronous processing still remain, the next file is selected (step S2505), and an original file name is reconstructed from the selected file (step S2506).

The reconstruction method varies depending on the file name conversion method used, but the method suited to the conversion method may be used.

The image sensing time of the selected file is obtained (step S2507).

Next, the camera ID of the camera from which that file is obtained is obtained based on the file name of the selected file (step S2508).

The file name, image sensing time, and camera ID obtained in this way are added to the file list (step S2509).

The flow returns to step S2504 to repeat the processing for all the files obtained by the synchronous processing.

Upon completion of the processing for all the files obtained by the synchronous processing, camera A finally transmits the file list to camera B (step S2510).

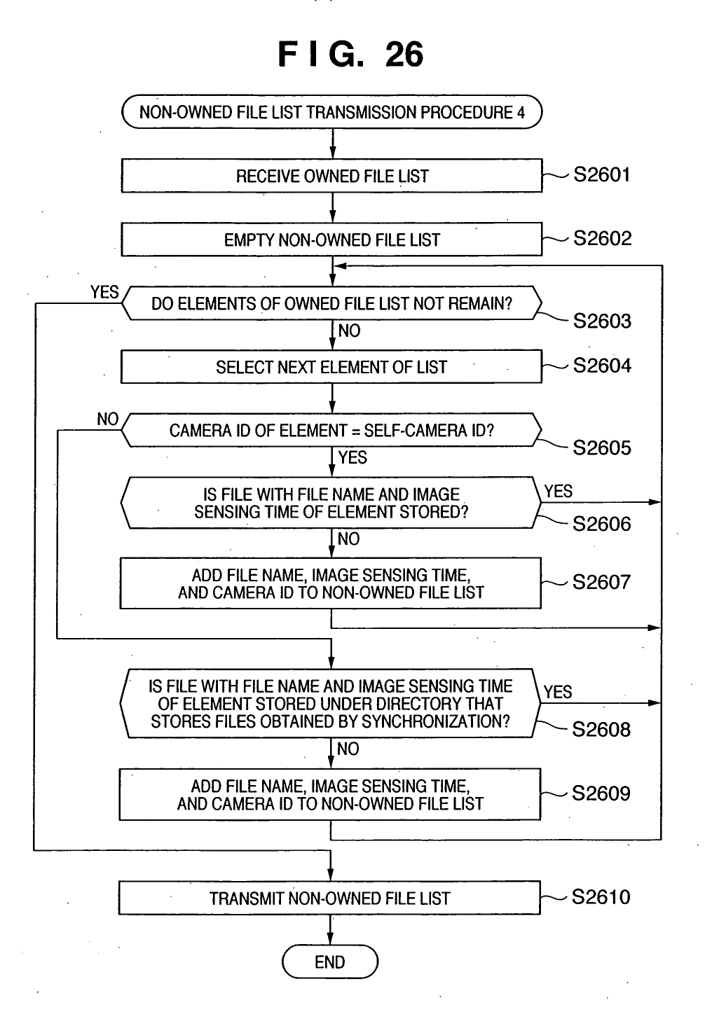

Procedure 4 for transmitting a non-owned file list from camera B as the embodiment for identifying a file using its image sensing time will be described below using the flowchart of FIG. 26.

The owned file list is received from camera A (step S2601).

A non-owned file list is emptied (step S2602).

It is checked if all elements in the owned file list of camera A received in step S2601 have been processed, i.e., if elements to be processed in the list still remain (step S2603).

If elements to be processed in the list still remain, the next element of the list is selected (step S2604). The element of the list includes the file name, image sensing time, and camera ID added to the list in step S2509.

It is checked if the camera ID of that element is that of the self-camera (step S2605). If the camera ID is the self-camera ID, it is checked if the self-camera has a file with the file name and image sensing time of the selected element (step S2606). If the self-camera has that file, the flow returns to step S2603.

If the self-camera does not have such file, the file name, image sensing time, and camera ID are added to the non-owned file list (step S2607), and the flow then returns to step S2603. If it is determined in step S2605 that the camera ID of the element is not the ID of the self-camera, it is checked if a file with the file name and image sensing time of the element is stored under the directory that stores files obtained by the synchronous processing (e.g., 999GIVEN in the example of FIG. 3) (step S2608).

If such file is stored, the flow returns to step S2603; otherwise, the file name, image sensing time, and camera ID of the element of interest are added to the non-owned file list (step S2609), and the flow then returns to step S2603.

Upon completion of the processing for all the files in the owned file list of camera A, camera B transmits the non-owned file list to camera A (step S2610).

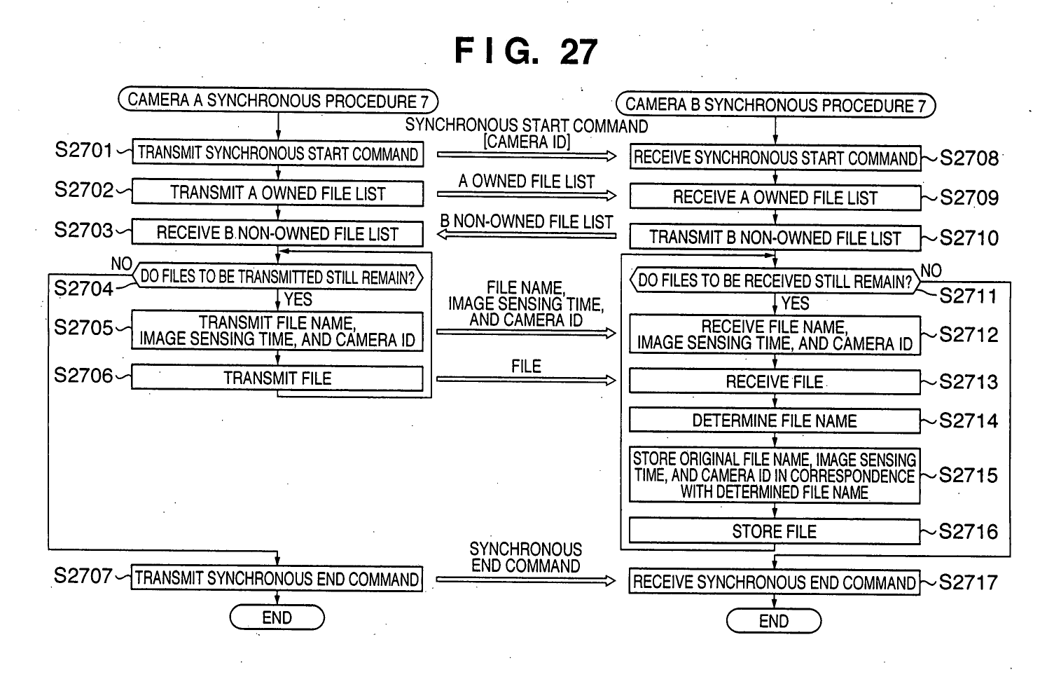

Synchronous procedure 7 from camera A to camera B when the file list transmission procedures in FIGS. 25 and 26 are used will be described below using the flowchart of FIG. 27.

Referring to FIG. 27, when the user of camera A performs a predetermined operation initially, camera A transmits a synchronous start command to camera B (steps S2701 and S2708).

Camera A transmits an owned file list according to the sequence in FIG. 25 (steps S2702 and S2709).

Upon reception of the A owned file list in step S2709, camera B transmits a list of files which are not owned by itself to camera A (steps S2710 and S2703). The transmission procedure follows the sequence in FIG. 26.

Upon reception of the B non-owned file list in step S2703, camera A transmits, to camera B, the file name, image sensing time, and camera ID described in the file list in correspondence with each of files to be transmitted (steps S2705 and S2712).

After that, camera A transmits the contents of the file to camera B (steps S2706 and S2713).

Camera B determines a file name based on the file name received in step S2712 (step S2714). Upon determination of the file name, the camera ID or image sensing time data may be used.

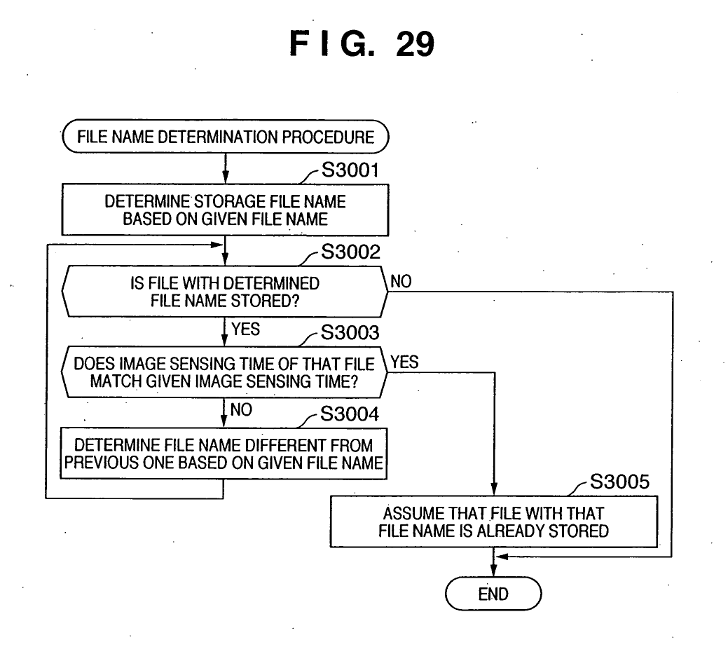

Details of the file name determination procedure described in step S2714 will be described below using the flowchart of FIG. 29.

Referring to FIG. 29, one file name upon storage is determined based on the file name given in step S2712 (step S3001).

It is checked if a file with the determined file name is stored (step S3002).

If no such file is stored, that file name is confirmed, and the processing ends.

However, if such file is stored, it is checked if the image sensing time of that stored file matches that given in step S2712 (step S3003).

If these times do not match, it is determined that these files are different ones, and a file name different from the previously determined file name is determined based on the file name given in step S2712 (step S3004), and the flow returns to step S3002.

If the two times match in step S3003, it is assumed that the file has already been stored (step S3005). In the sequence of FIG. 27, since only files which are included in the non-owned file list sent from camera A to camera B are sent from camera A, the flow does not normally reach this step. However, when a protocol that may send even files owned by camera B is used, if it is determined that the file has already been stored, that file may be ignored, or the incoming file may overwrite the currently stored file.

Referring back to FIG. 27, the original file name, image sensing time, and camera ID are stored in a correspondence table (not shown) in correspondence with the determined file name (step S2715).

The file is stored in the FlashROM 209 with the determined file name (step S2716), and the processing ends via transmission/reception of a synchronous end command (steps S2707 and S2717).

In the description of step S2715, the image sensing time data is also stored in the correspondence table. However, when the image sensing time data is included in the file name or the file, as described above, the image sensing time need not be stored in the correspondence table.

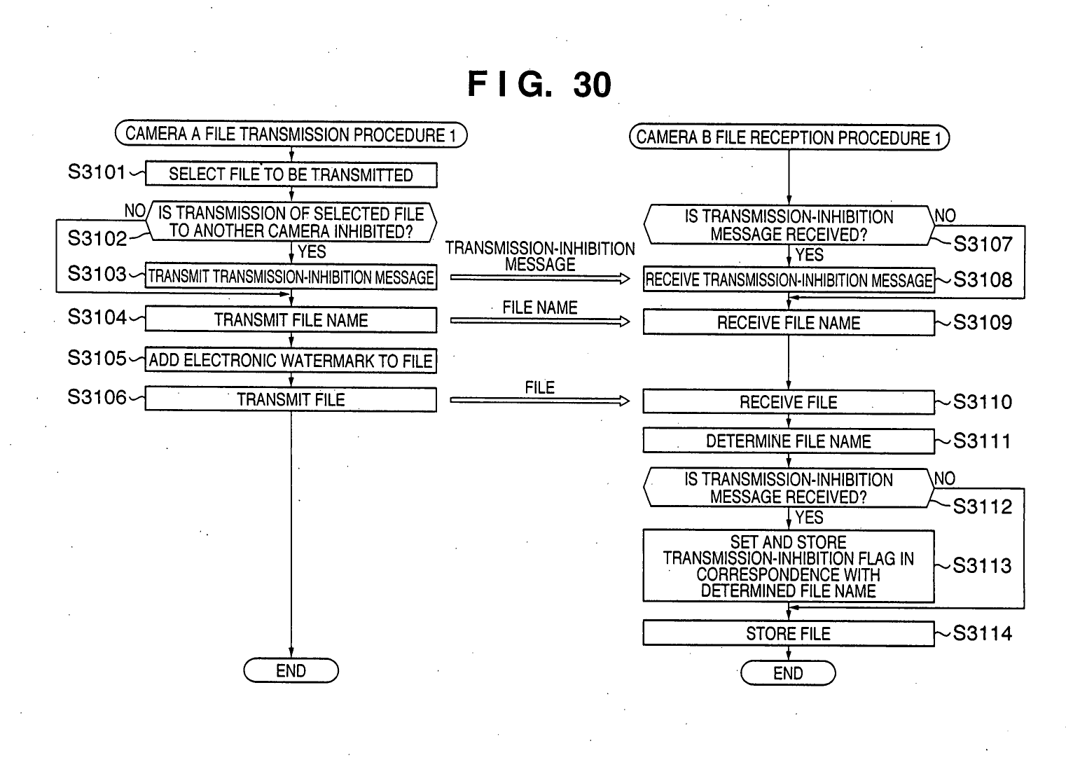

An embodiment in which camera A can inhibit camera B from sending a given file to another camera when file synchronous processing is done from camera A to camera B will be described below using the flowchart of FIG. 30.

FIG. 30 is a flowchart showing procedure 1 for transmitting one file from camera A to camera B upon synchronization. In this flowchart, synchronous start and end procedures, and file list transmission/reception procedures are excluded from the aforementioned flowchart of the synchronous procedure. Also, loop processing for transmitting a plurality of files is excluded.

After the synchronous processing starts and the file list is exchanged, camera A selects a file to be transmitted (step S3101).

Camera A checks if it inhibits camera B, with which the synchronous processing is currently in progress, from transmitting the selected file to a camera (e.g., camera C) other than camera A later (step S3102). For this checking process, assume that a flag indicating if transmission is inhibited is stored on the RAM 203 or a storage medium such as the FlashROM 209 or the like.

If the selected file is a transmission-inhibited file, camera A transmits a transmission-inhibition message to camera B (steps S3103 and S3108).

If the selected file is not inhibited from being transmitted, i.e., if the file can be transmitted to everyone, the flow skips step S3103.

Camera A then transmits the file name (steps S3104 and S3109).

Camera B checks in step S3107 if the transmission-inhibition message or the file name is received, thus coping with a case wherein no transmission-inhibition message is received.

Camera A embeds an electronic watermark indicating that the file was sensed by camera A to the file to be transmitted (step S3105).

By embedding the electronic watermark, if camera B sends that file to another camera without complying with the agreement of transmission inhibition, such violation can be easily detected. In this sense, when the synchronous processing is executed with camera B, electronic watermark information indicating that fact is preferably appended to improve the effect.

Since the electronic watermark is certification means of unauthorized copy or the like upon use of the copyright, the procedure for appending the electronic watermark can be added to the synchronous procedures other than FIG. 30.

When the synchronous processing is permitted among a plurality of apparatuses, correspondence between the files and cameras which transmit them cannot be recognized unless the received files are strictly managed by the aforementioned method using the file names or directory names.

Especially, there is a concern about this when files are stored in a detachable memory card, and the contents of that memory card are copied to another storage medium by another computer apparatus. Therefore, it is preferable to indicate the originality of a file by appending the electronic watermark.

Referring back to FIG. 30, camera A transmits the file appended with the electronic watermark to camera B (steps S3106 and S3110).

Camera B determines a storage file name based on the file name received in step S3109 (step S3111).

It is then checked if the transmission-inhibition message is received in correspondence with that file (step S3112).

If that message is received, a transmission-inhibition flag is set and stored in a storage medium in correspondence with the determined file name (step S3113). If no message is received, the flow skips this step.

Finally, the file is stored with the determined file name (step S3114), thus ending the processing.

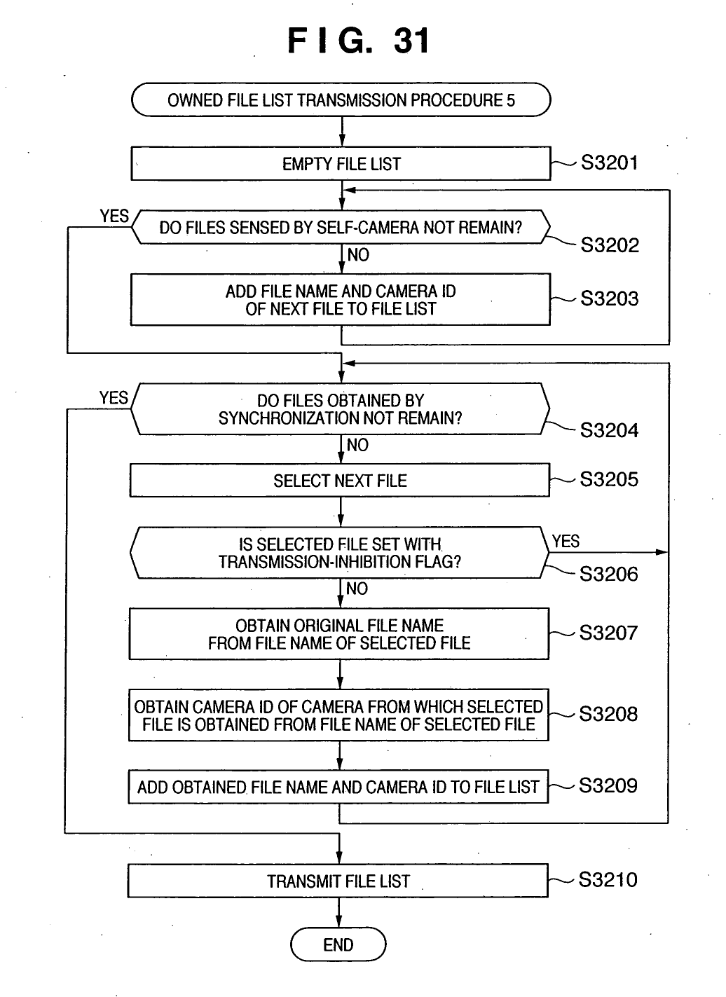

When the above transmission-inhibition setting is allowed, camera B assumes not to own the transmission-inhibited file when it executes synchronous processing with another camera. Owned file list transmission procedure 5 in this case will be described below using the flowchart of FIG. 31.

Referring to FIG. 31, a file list is emptied initially (step S3201).

Next, it is checked if files sensed by the self-camera do not remain (step S3202). If sensed files still remain, the next file is selected, and the file name of that file and the camera ID of the self-camera are added to the file list (step S3203).

After that, the flow returns to step S3202 to process all the files sensed by itself.

Note that all of files selected in advance may be added to the file list, as described above, in place of processing all the files sensed by the self-camera.

Upon completion of the processing for all the files sensed by the self-camera, it is checked in turn if files obtained by the synchronous processing with another camera do not remain (step S3204).

If files obtained by the synchronous processing still remain, the next file is selected (step S3205).

It is checked if the transmission-inhibition flag is set in correspondence with the selected file (step S3206). This checking process uses the data stored in step S3113. If the transmission-inhibition flag is set, the flow returns to step S3204 without adding this file to the file list. If the transmission-inhibition flag is not set, the flow advances to the next step, and an original file name is reconstructed from the selected file (step S3207).

Next, the camera ID of the camera from which that file is obtained is obtained based on the file name of the selected file (step S3208).

The file name and camera ID obtained in this way are added to the file list (step S3209).

The flow returns to step S3204 to repeat the processing for all the files obtained by the synchronous processing.

Upon completion of the processing for all the files obtained by the synchronous processing, the file list is finally transmitted (step S3210).

With the procedures shown in FIGS. 30 and 31, this file can be designated as a transmission-inhibited file for the synchronous partner.

A case will be examined below wherein camera A designates a file as a transmission-inhibited file for camera B, but it does not designate it as a transmission-inhibited file for camera C, and the synchronous processing is then executed between cameras B and C.

In this case, as for the synchronous processing from camera B to camera C, since camera B does not add the file in question to the owned file list, that file is never sent from camera B to camera C.

However, as for the synchronous processing from camera C to camera B, since camera C adds the file in question to the owned file list, if camera B adds the file in equation to the non-owned file list, it receives that file from camera C.

In such case, in one method, camera B may receive that file from camera C but ignore it, i.e., may not store the received file.

In another method, camera B may receive the file from camera C, and may overwrite the old file received from camera A. At this time, the transmission-inhibition flag for that file is cleared. That is, upon executing the subsequent synchronous processing with another camera, this file is added to the owned file list.

Of course, in still another method, camera B simply does not add the file in question to the non-owned file. In such case, that file is not sent from camera C.

The sequence in FIG. 31 shows a procedure in which a file obtained by the synchronous processing is not added to those which are owned by the self-camera.

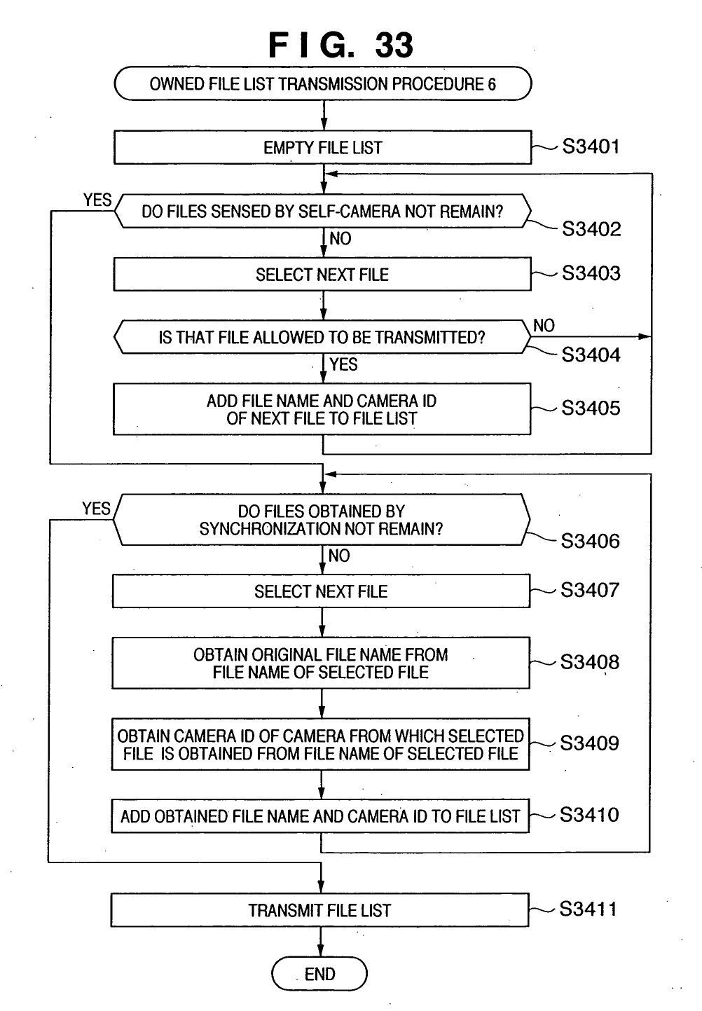

Owned file list transmission procedure 6 when files sensed by the self-camera are not added to those which are owned by the self-camera will be described below with reference to the flowchart of FIG. 33.

Referring to FIG. 33, a file list is emptied initially (step S3401). Next, it is checked if files sensed by the self-camera do not remain (step S3402). If sensed files still remain, the next file is selected, and the file name of that file and the camera ID of the self-camera are added to the file list (step S3403).

It is checked if the selected file is allowed to be transmitted (step S3404). For this checking process, assume that a flag indicating if a file is allowed to be transmitted is stored in a storage medium for each file sensed by the self-camera. If the selected file is not to be transmitted, the flow returns to step S3402 without being added to the file list. If the selected file is allowed to be transmitted, the file name of that file and the camera ID of the self-camera are added to the file list (step S3405).

After that, the flow returns to step S3402 to process all the files sensed by itself.

The processes in step S3406 and subsequent steps are the same as those in step S804 and subsequent steps in FIG. 8.

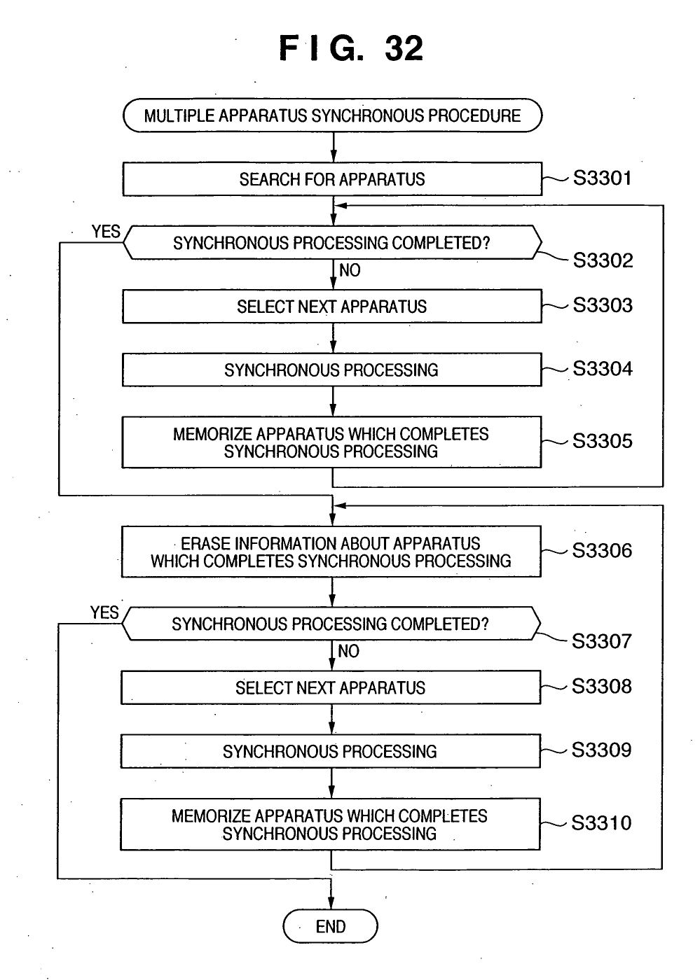

An embodiment when three or more apparatuses execute synchronous processing with each other will be described below using the flowchart of FIG. 32.

When three or more apparatuses completely execute synchronous processing with each other, each apparatus can execute synchronous processing with all the other apparatuses as a simplest method.

If there are a total of n apparatuses, when each apparatus executes synchronous processing with all the other apparatuses, the synchronous processing is required ₙC₂ times (the number of combinations that take 2 out of n; n*(n−1)/2). This number of times increases with increasing n. Hence, a method that can complete synchronous processing a fewer number of time is demanded.

FIG. 32 shows such procedure. Referring to FIG. 32, an apparatus which serves as a master apparatus starts search processing of another apparatus (step S3301).

To be a master apparatus, assume that the user makes a predetermined operation.

A practical search method depends on network means equipped in that apparatus. When the camera 101a searches for cameras connected on the LAN 102, it may use a broadcast packet of TCP/IP. When the camera 101a searches for cameras on the Internet 103, a method using a server (not shown) that recognizes individual camera positions or using a P2P (Peer To Peer) technique may be adopted. When wireless connection is used, a search method according to a wireless protocol used may be adopted.

The master apparatus checks if synchronous processing is complete (step S3302). When the processing has just been started, it is not completed as a matter of course.

The master apparatus selects an apparatus which does not complete synchronous processing (step S3303), and executes one of the aforementioned synchronous processes (step S3304).

Upon completion of the synchronous processing, the mater apparatus memorizes that apparatus (step S3305). This step is done to select in step S3303 the apparatus which does not complete synchronous processing.

Then, the flow returns to step S3302. The repetition of these steps completes the fist-time synchronous processing with all the other apparatuses.

At this time, the master apparatus stores files of another camera. Also, another camera obtain files of the master apparatus.

Next, the master apparatus erases information about the apparatus which has completed the synchronous processing (step S3306). As a result, synchronous processing that starts from step S3307 can be applied to all the other apparatuses.

From steps S3307 to S3310, the synchronous processing is executed and completed in the same manner as in steps S3302 to S3305.

At the timing of step S3306, since the master apparatus stores files of all the other apparatuses, the apparatuses other than the master apparatus can obtain files of all the other apparatuses by the synchronous processing in step S3307 and subsequent steps.

With this procedure, the synchronous processing between respective apparatuses can be completely executed by 2*(n−1) times of processing.

Therefore, when n is 5 or more, this procedure can reduce the number of times of synchronous processing compared to a case wherein each apparatus executes synchronous processing with all the other apparatuses.

The present invention has been explained. The present invention is applied not only to digital cameras but also methods for transmitting/receiving files. Hence, computers having communication functions are included in the scope of the present invention.

When the present invention is applied to a general computer, since files are not only image files, the concept “image sensing times of files” cannot be used to identify files, but creation times of files can be used instead.

Alternatively, an identifier which can uniquely identify a resource, i.e., a file in the world (e.g., URI (Universal Resource Identifier) may be used.

Alternatively, an electronic signature may be appended using a value obtained by Message Digest to indicate if files have identical contents.

The present invention is not limited to the above embodiments and various changes and modifications can be made within the spirit and scope of the present invention. Therefore to apprise the public of the scope of the present invention, the following claims are made.

### CLAIM OF PRIORITY

This application claims priority from Japanese Patent Application No. 2004-265931 filed on Sep. 13, 2004, which is hereby incorporated by reference herein.

What is claimed is:

1. A communication system for transmitting/receiving files between a plurality of apparatuses, wherein
a transmission end comprises:
identification information transmitting means for transmitting identification information of a self-apparatus; and
file transmitting means for transmitting a file and file name owned by the self-apparatus, and
a reception end comprises:
identification information receiving means for receiving the identification information of said transmission end;
file receiving means for receiving the file and file name transmitted from said transmission end; and
file name determination means for determining a file name to be given upon storing the received file in the self-apparatus on the basis of the identification information and file name received from said transmission end.

2. The system according to claim 1, wherein said transmission end further comprises list transmitting means for transmitting a list of files owned by the self-apparatus, and
said reception end further comprises:
judging means for judging non-owned files from the list of files received from said transmission end;
storing means for storing the file received from said transmission end by appending the file name determined by said file name determination means to that file;
file name reconstruction means for reconstructing an original file name and identification information appended by said transmission end on the basis of the file name stored in said storing means; and
list production means for producing a list of files owned by the self-apparatus, which includes the reconstructed file name and identification information.

3. The system according to claim 1, wherein said reception end further comprises:
directory name determination means for determining a name of a directory that stores files on the basis of the identification information; and
directory production means for producing a directory with the determined name on said storing means, and
said storing means stores files in the produced directory.

4. The system according to claim 3, wherein said reception end further comprises identification information reconstruction means for reconstructing the identification information of said transmission end on the basis of the directory name produced on said storing means, and
said list production means produces a list of files owned by the self-apparatus, which includes the reconstructed identification information.

5. The system according to claim 2, wherein said reception end further comprises file association means for associating and storing the identification information of said transmission end, the determined file name, and the reconstructed file name.

6. The system according to claim 2, wherein said reception end further comprises directory association means for associating and storing the identification information of said transmission end and the determined directory name.

7. The system according to claim 1, wherein said reception end further comprises:
file identification information receiving means for receiving file identification information of a file owned by said transmission end; and
file identification information acquisition means for acquiring file identification information of a file owned by the self-apparatus, and
said judging means judges a file which is not owned by the self-apparatus by comparing the two pieces of file identification information, and
said file receiving means receives the file which is judged to be not owned by the judging means.

8. The system according to claim 7, wherein said file name determination means determines a first file name on the basis of the file name and identification information of the apparatus included in the file identification information, and determines a second file name different from the first file name when a file having the first file name already exists.

9. The system according to claim 7, wherein the file identification information includes a file name, time information of production of a file, and identification information of an apparatus which has produced the file.

10. The system according to claim 1, wherein said reception end further comprises transmission file selection means for selecting files to be transmitted to said transmission end from files owned by the self-apparatus.

11. The system according to claim 1, wherein said transmission end further comprises electronic watermark addition means for adding electronic watermark information to a file to be transmitted to said reception end.

12. The system according to claim 1, wherein each of said transmission and reception ends further comprises image sensing means for sensing an image of an object by photoelectric conversion, and the file is an image file sensed by said image sensing means.

13. A communication apparatus for receiving a file from another apparatus, comprising:
identification information receiving means for receiving identification information from a transmission end;
file receiving means for receiving a file and file name transmitted from the transmission end; and
file name determination means for determining a file name to be given upon storing the received file in a self-apparatus on the basis of the identification information and file name received from the transmission end.

14. A communication system in which a second apparatus which receives a file from a first apparatus transmits the file received from the first apparatus to a third apparatus, wherein
the first apparatus comprises:
transmission means for transmitting a file owned by a self-apparatus and inhibition information that inhibits the file from being transmitted to the third apparatus, and
the second apparatus comprises:
receiving means for receiving the file owned by the first apparatus and the inhibition information;
storing means for storing the file owned by the first apparatus, in association with the inhibition information; and
transmitting means for transmitting files owned by the self-apparatus except for the file associated with the inhibition information to the third apparatus.

15. A communication apparatus for receiving a file from another apparatus, comprising:
storing means for storing information of an apparatus which completes a communication;
judging means for judging if an apparatus which can communicate with a self-apparatus and does not complete the communication exists;
receiving means for receiving a file from the judged apparatus; and
control means for executing reception of files by said receiving means until said judging means judges that no apparatus which does not complete the communication exists, and for, when said judging means judges that no apparatus which does not complete the communication exists, erasing the information of the apparatuses stored in said storing means.

16. A communication method for transmitting/receiving files between a plurality of apparatuses, wherein
a transmission end comprises:
an identification information transmitting step of transmitting identification information of a self-apparatus; and
a file transmitting step of transmitting a file and file name owned by the self-apparatus, and
a reception end comprises:
an identification information receiving step of receiving the identification information of the transmission end;
a file receiving step of receiving the file and file name transmitted from the transmission end; and
a file name determination step of determining a file name to be given upon storing the received file in the self-apparatus on the basis of the identification information and file name received from the transmission end.

17. A communication method for receiving a file from another apparatus, comprising:
an identification information receiving step of receiving identification information from a transmission end;
a file receiving step of receiving a file and file name transmitted from the transmission end; and
a file name determination step of determining a file name to be given upon storing the received file in a self-apparatus on the basis of the identification information and file name received from the transmission end.

18. A communication method in which a second apparatus which receives a file from a first apparatus transmits the file received from the first apparatus to a third apparatus, wherein
the first apparatus comprises:
a transmission step of transmitting a file owned by a self-apparatus and inhibition information that inhibits the file from being transmitted to the third apparatus, and
the second apparatus comprises:
a receiving step of receiving the file owned by the first apparatus and the inhibition information;
a storing step of storing the file owned by the first apparatus in association with the inhibition information; and
a transmitting step of transmitting files owned by the self-apparatus except for the file associated with the inhibition information to the third apparatus.

19. A communication method for receiving a file from another apparatus, comprising:
a storing step of storing information of an apparatus which completes a communication;
a judging step of judging if an apparatus which can communicate with a self-apparatus and does not complete the communication exists;
a receiving step of receiving a file from the judged apparatus; and
a control step of executing reception of files in the receiving step until it is judged in the judging step that no apparatus which does not complete the communication exists, and erasing, when it is judged in the judging step that no apparatus which does not complete the communication exists, the information of the apparatuses stored in the storing step.

20. A program for making a computer implement a communication method of claim 16.

21. A computer-readable storage medium storing a program of claim 20.

22. A program for making a computer implement a communication method of claim 17.

23. A computer-readable storage medium storing a program of claim 22.

24. A program for making a computer implement a communication method of claim 18.

25. A computer-readable storage medium storing a program of claim 24.

26. A program for making a computer implement a communication method of claim 19.

27. A computer-readable storage medium storing a program of claim 26.
